(19) United States
(12) Patent Application Publication
(10) Pub. No.: US 2024/0340755 A1
(43) Pub. Date: Oct. 10, 2024

(54) APPARATUS AND METHOD FOR HANDOVER IN NETWORK

(71) Applicant: SAMSUNG ELECTRONICS CO., LTD., Suwon-si (KR)

(72) Inventors: Jonas SEDIN, Staines (GB); Chadi KHIRALLAH, Middlesex (GB)

(21) Appl. No.: 18/629,794

(22) Filed: Apr. 8, 2024

(30) Foreign Application Priority Data
Apr. 6, 2023 (GB) 2305220.2

(51) Int. Cl. H04W 36/36; H04L 1/1812; H04W 36/00; H04W 84/06

(52) U.S. Cl. CPC H04W 36/362; H04L 1/1812; H04W 36/00725; H04W 84/06

(57) ABSTRACT

The disclosure relates to a 5G or 6G communication system for supporting a higher data transmission rate. There is disclosed a method, for a second base station in a network comprising a User Equipment (UE), a first base station, and the second base station. The method is for performing Random Access Channel (RACH)-less handover of the UE from the first base station to the second base station. The method comprises: obtaining a Conditional Handover (CHO) configuration (e.g., execution condition); determining a RACH-less Uplink (UL) grant configuration; transmitting, to the first base station, the RACH-less UL grant (e.g., in a HANDOVER REQUEST ACK message); and monitoring for UL RACH-less transmissions from the UE (e.g., a RRCConnectionReconfigurationComplete message) or scheduling Physical Downlink Control Channel (PDCCH) assignments to the UE, based on the CHO configuration.

### CROSS-REFERENCE TO RELATED APPLICATION

This application is based on and claims priority under 35 U.S.C. § 119 to United Kingdom Patent Application No. 2305220.2 filed on Apr. 6, 2023, in the United Kingdom Intellectual Property Office, the disclosure of which is incorporated by reference herein in its entirety.

### BACKGROUND

### 1. Field

Certain examples of the present disclosure provide one or more techniques for performing handover in a network. For example, certain examples of the present disclosure provide one or more techniques for performing Conditional Handover (CHO) with Random Access Channel (RACH)-less in a 3^{rd} Generation Partnership Project (3GPP) 5th Generation (5G) New Radio (NR) Non Terrestrial Network (NTN).

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

The present disclosure is defined in the independent claims. Advantageous features are defined in the dependent claims. Embodiments or examples disclosed in the description and/or figures falling outside the scope of the claims are to be understood as examples useful for understanding the present disclosure.

Other aspects, advantages and salient features of the disclosure will become apparent to those skilled in the art from the following detailed description taken in conjunction with the accompanying drawings.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates NTN Release 17 architecture and scenario;

FIG. 2 illustrates a simplified conditional handover procedure;

FIG. 3 illustrates CHO handover using CondeventT1;

FIG. 4A illustrates a type of RACH-less handover in which a UE is configured with uplink grants, and FIG. 4B illustrates a type of RACH-less handover in which the UE is configured to monitor PDCCH of a target cell;

FIG. 5A illustrates performing normal handover (HO) with RACH-less, and FIG. 5B illustrates performing conditional handover (CHO) with RACH-less and highlighting a problem of when a target eNB shall start monitoring for UL transmissions;

FIG. 6 illustrates an exemplary technique for sending CHO configuration from a source cell to a target cell;

FIG. 7 illustrates an exemplary technique for sending a request for a target eNB to configure a CHO trigger, which is later received by a source eNB in a HANDOVER REQUEST ACKNOWLEDGE message;

FIG. 8 illustrates a validity duration for RACH-less in an example in which a UE cannot perform RACH-less but has to complete CHO using a random access procedure rather than RACH-less;

FIG. 9 illustrates an exemplary technique for collecting configuration (RRCReconfiguration) elements from different eNBs representing the configuration for different cells;

FIG. 10 illustrates an exemplary technique for using an ephemeris Identity (ID) to reduce the number of SIB31 elements;

FIG. 11 illustrates an exemplary technique for including the SIB31 element outside of the RRCReconfiguration in HandoverCommand so that a separate list can be created by the source eNB; and

FIG. 12 illustrates a block diagram of an exemplary network entity that may be used in certain examples of the present disclosure.

### DETAILED DESCRIPTION

### Overview of NTN

One of the areas currently under development in 3GPP 5G wireless technology is support for NTNs. An NTN is a network in which one or more nodes (e.g., a Next Generation (NG) Radio Access Network (RAN) node) are provided by a non-terrestrial infrastructure, for example a satellite or High Altitude Platform Station (HAPS). Advantages of using an NTN include (i) extending coverage to regions, such as remote areas, with limited or no coverage from more traditional terrestrial networks, (ii) providing continuous coverage in the event of inoperability of traditional terrestrial networks, such as during natural disasters, and (iii) enhancing overall reliability, resilience and capacity when used in conjunction with existing terrestrial networks.

A satellite network implementing a network node provides coverage through one or more radio beams forming a “footprint” on the surface of the Earth defining a coverage area or cell. An NTN cell may be Earth-moving (i.e., moving over the Earth's surface according to the motion of the satellite, for example in the case of a Lower Earth Orbit (LEO) satellite), Earth-fixed (i.e., a fixed area of the Earth's surface, for example in the case of a Geosynchronous Equatorial Orbit (GEO) satellite) or quasi-Earth-fixed (i.e., a fixed area of the Earth's surface but is maintained for only a limited time as the satellite passes by).

### Overview of Internet of Things (IoT) NTN and NR NTN

IoT NTN was a 3GPP study and work item in 3GPP Release 17 (RP-202689, RAN #90 December 2020) to provide NTN access for Evolved Universal Terrestrial Radio Access Network (E-UTRAN) IoT devices (e.g., Narrowband (NB)-IoT and Long Term Evolution Machine Type Communication (LTE-M), including enhanced Machine Type Communication (eMTC)). As noted in 3GPP RP-202689, IoT operation is critical in remote areas with low/no cellular connectivity for many different industries. The capabilities of NB-IoT and eMTC are a good fit for many applications but some applications may require satellite connectivity to provide coverage beyond terrestrial deployments.NR NTN was a work item in Release 17 to specify adaptation to allow NR to function over NTN (RP-211557, RAN #91-e March 2021).

Following the work items in Release 17 there were work items to enhance NR NTN (RP-220953, RAN #95-c March 2022) and IoT NTN (RP-220979, RAN #95-e March 2022) in Release 18.

### Overview of NB-IoT and LTE-M

NB-IoT is a 3GPP-defined network based on 4^{th} Generation (4G) E-UTRAN that supports ultra-low complexity devices with very narrow bandwidth that was introduced in 3GPP Release 13. The use case of NB-IoT is to serve massive IoT application, where requirements for instance are to support enhanced coverage, power-efficient operation and a massive number of devices. Some of the features introduced are:
Support for enhanced coverage through low bandwidth and extreme amounts of repetitions.
Power efficient operation by allowing the User Equipment (UE) to sleep for very long times, relaxed requirements and more efficient signal to establish with a cell.

LTE-M or eMTC is a 3GPP-defined network that is an extension of 4G E-UTRAN that supports low-complexity devices with more narrow bandwidths compared to normal LTE and further simplifications of procedures. Similarly to NB-IoT, the use case is to serve massive IoT, but with more capabilities. Instead of being an entirely new type of device with major air interface changes as in NB-IoT, the LTE-M inherits most feature of a regular LTE device, but with some adaptations for low complexity considerations.

### Overview of NTN System Information

As NTN has a number of NTN-specific information elements that are only required when accessing an NTN cell, and also due to the rather large information elements it was agreed that new System Information Blocks (SIB) was needed.

In NR NTN SIB19 contains the required information to access an NTN cell:
3GPP TS 38.331 V17.3.0
   SIB19
      SIB19 contains satellite assistance information for NTN access.
      SIB19 information element is as follows in Table 1.

TABLE 1
-- ASN1START
-- TAG-SIB19-START
SIB19-r17 ::= SEQUENCE {

| | | |
|---|---|---|
| ntn-Config-r17 | NTN-Config-r17 | OPTIONAL, -- Need R |
| t-Service-r17 | INTEGER (0..549755813887) | OPTIONAL, -- Need R |
| referenceLocation-r17 | ReferenceLocation-r17 | OPTIONAL, -- Need R |
| distanceThresh-r17 | INTEGER(0..65525) | OPTIONAL, -- Need R |
| ntn-NeighCellConfigList-r17 | NTN-NeighCellConfigList-r17 | OPTIONAL, -- Need |

R

| | | |
|---|---|---|
| lateNonCriticalExtension | OCTET STRING | OPTIONAL, |

```
  ...,
  [[
```

| | | |
|---|---|---|
| ntn-NeighCellConfigListExt-v1720 | NTN-NeighCellConfigList-r17 | OPTIONAL -- |

Need R
]]
}

| | |
|---|---|
| NTN-NeighCellConfigList-r17 ::= | SEQUENCE (SIZE(1..maxCellNTN-r17)) OF NTN- |

NeighCellConfig-r17

| NTN-NeighCellConfig-r17 ::= | SEQUENCE { | |
|---|---|---|
| ntn-Config-r17 | NTN-Config-r17 | OPTIONAL, -- Need R |
| carrierFreq-r17 | ARFCN-ValueNR | OPTIONAL, -- Need R |
| physCellId-r17 | PhysCellId | OPTIONAL -- Need R |

}
-- TAG-SIB19-STOP
-- ASN1STO

Descriptions for various fields set forth in Table 1 are provided in Table 2 below.

TABLE 2
SIB19 field descriptions

distanceThresh
Distance from the serving cell reference location and is used in location-based
measurement initiation in RRC_IDLE and RRC_INACTIVE, as defined in TS 38.304
[20]. Each step represents 50 m.
ntn-Config
Provides parameters needed for the UE to access NR via NTN access such as Ephemeris
data, common TA parameters, k_offset, validity duration for UL sync information and
epoch.
ntn-NeighCellConfigList, ntn-NeighCellConfigListExt
Provides a list of NTN neighbour cells including their ntn-Config, carrier frequency and
PhysCellId. This set includes all elements of ntn-NeighCellConfigList and all elements of
ntn-NeighCellConfigListExt. If ntn-Config is absent for an entry in ntn-
NeighCellConfigListExt, the ntn-Config provided in the entry at the same position in ntn-
NeighCellConfigList applies.
referenceLocation
Reference location of the serving cell provided via NTN quasi-Earth fixed system and is
used in location-based measurement initiation in RRC_IDLE and RRC_INACTIVE, as
defined in TS 38.304 [20].
t-Service
Indicates the time information on when a cell provided via NTN quasi-Earth fixed system
is going to stop serving the area it is currently covering. The field indicates a time in
multiples of 10 ms after 00:00:00 on Gregorian calendar date 1 Jan., 1900 (midnight
between Sunday, Dec. 31, 1899 and Monday, Jan. 1, 1900). The exact stop time
is between the time indicated by the value of this field minus 1 and the time indicated by
the value of this field.

In IoT NTN SIB31 contains the required information to access an IoT NTN cell:
3GPP TS 36.331 V17.3.0
   SystemInformationBlockType31
      The IE SystemInformationBlockType31 contains satellite assistance information for the serving cell. SystemInformationBlockType31 is only signalled in a NTN cell.
      SystemInformationBlockType31 information element is as follows in Table 3.

TABLE 3
-- ASN1START
SystemInformationBlockType31-r17 ::= SEQUENCE {

| | |
|---|---|
| servingSatelliteInfo-r17 | ServingSatelliteInfo-r17, |
| lateNonCriticalExtension | OCTET STRING |

OPTIONAL,
...
}

| | |
|---|---|
| ServingSatelliteInfo-r17 ::= | SEQUENCE { |
| ephemerisInfo-r17 | CHOICE { |
| stateVectors | EphemerisStateVectors-r17, |
| orbitalParameters | EphemerisOrbitalParameters-r17 |

},

| | |
|---|---|
| nta-CommonParameters-17 | SEQUENCE { |
| nta-Common-r17 | INTEGER (0..8316827) |

OPTIONAL, -- Need OP

| | |
|---|---|
| nta-CommonDrift-r17 | INTEGER (−261935..261935) |

OPTIONAL, -- Need OP

| | | |
|---|---|---|
| nta-CommonDriftVariation-r17 | INTEGER (0..29479) | OPTIONAL -- |

Need OP
},

| | |
|---|---|
| ul-SyncValidityDuration-r17 | ENUMERATED {s5, s10, s15, s20, s25, s30, s35, s40, |

s45, s50, s55, s60, s120, s180, s240, s900},

| | |
|---|---|
| epochTime-r17 | SEQUENCE { |
| startSFN-r17 | INTEGER (0..1023), |
| startSubFrame-r17 | INTEGER (0..9) |

}

| | |
|---|---|
| | OPTIONAL, -- Need OP |
| k-Offset-r17 | INTEGER (0..1023), |
| k-Mac-r17 | INTEGER (1..512) |

OPTIONAL, -- Need OP
...
}
-- ASN1STOP

Descriptions for various fields set forth in Table 1 are provided in Table 4 below.

TABLE 4
SystemInformationBlockType31 field descriptions

epochTime
Epoch time of the satellite ephemeris data and common TA parameters, see TS 36.213
[23]. The reference point for epoch time of the serving satellite ephemeris and Common
TA parameters is the uplink time synchronization reference point.
epochTime is the starting time of a DL subframe indicated by startSFN and
startSubframe. For serving cell, the startSFN indicates the current SFN or the next
upcoming SFN after the frame where the message indicating the epochTime is received.
If the field is absent, the UE uses the starting time of the DL subframe corresponding to
the end of the SI window during which the SI message carrying SIB31 is transmitted.
E-UTRAN always includes epochTime when SystemInformationBlockType31 is provided
through dedicated signalling.
In case of handover or conditional handover, this field is based on the timing of the target
cell, i.e., the startSFN and startSubFrame number indicated in this field refers to the SEN
and sub-frame of the target cell, and UE considers the target cell epoch time (indicated by
the startSFN and startSubFrame in this field) to be the frame nearest to the frame where
RRCConnectionReconfiguration message is received.
k-Mac
Scheduling offset used when downlink and uplink frame timing are not aligned at the
eNB, see TS 36.213 [23]. Unit in ms.
If the field if absent, the UE uses the (default) value of 0.
k-Offset
Scheduling offset used in the timing relationships in NTN, see TS 36.213 [23]. Unit in
ms.
nta-Common
Network-controlled common TA, see TS 36.213 [23]. Unit of μs.
Step of 32.55208 × 10⁻³ μs. Actual value = field value * 32.55208 × 10⁻³.
If the field is absent, the UE uses the (default) value of 0.
nta-CommonDrift
Drift rate of the common TA, see TS 36.213 [23]. Unit of μs/s.
Step of 0.2 × 10⁻³ μs/s. Actual value = field value * 0.2 × 10⁻³.
If the field is absent, the UE uses the (default) value of 0.
nta-CommonDriftVariation
Drift rate variation of the common TA, see TS 36.213 [23]. Unit of μs/s².
Step of 0.2 × 10⁻⁴ μs/s². Actual value = field value * 0.2 × 10⁻⁴.
If the field is absent, the UE uses the (default) value of 0.
orbitalParameters
Instantaneous values of the satellite orbital parameters. The signalled values are only
valid for the duration as defined by ul-SyncValidityDuration and epochTime.
stateVectors
Instantaneous values of the satellite state vectors. The signalled values are only valid for
the duration as defined by ul-SyncValidityDuration and epochTime.
ul-SyncValidityDuration
Validity duration of the satellite ephemeris data and common TA parameters, i.e.,
maximum time duration (from epochTime) during which the UE can apply the satellite
ephemeris without acquiring new satellite ephemeris, see TS 36.213 [23]. Unit in second.
Value s5 corresponds to 5 seconds, value s10 corresponds to 10 seconds and so on.

The system information contains the following:
Serving cell ephemeris elements. This allows the UE to calculate the satellite position for doppler and time pre-compensation. This information may be provided in two formats:
   PVT format. This describes a (X,Y,Z) position as well as a speed vector (vX, vY, vZ).
   Orbital parameters. This describes the orbital movements of the satellite which is then used to infer the satellite position.
TA common parameters. This provides the common timing advance parameters which is introduced to compensate for the feeder link delays. The signalling comprises the following (in total taking up 57 bits):
   Absolute TA common (23 bits).
   Drift of the TA common, defining how the TA common drifts, i.e., the first derivative of the TA common (19 bits).
   Variation of the TA common, defining how the TA common varies, i.e., the second derivative of the TA common (15 bits).
Synchronization validity duration. This is used to define how long the ephemeris and TA common is valid.
Epoch time. This defines when the synchronization validity duration should start.
K-Offset. This is a scheduling offset for timing relationship in NTN.
K-Mac. This is a scheduling offset used when the downlink and uplink frame timing is not aligned.
NR NTN specific information also includes (as part of 3GPP TS 38.331):
   T-Service (signalled in SIB3 in IoT NTN).
   Reference location and distance threshold. This is used for location-based measurement initiation in RRC IDLE and RRC Connected mode.
   Neighbour cell ephemeris. This is used for idle mode measurements.

### Overview of Acquisition of NTN System Information

As ephemeris information constantly changes due to the movement of the NTN payload (e.g., satellite), there may be a need to make sure that the UE is correctly synchronized. Thus, whenever a UE connects to an eNB, the UE may need to read the system information (e.g., SIB19 or SIB31).

In IoT NTN, every time SIB31 is read, a timer (T317) associated with the ephemeris element is started. At expiry of T317, the UE is no longer considered synchronized and should re-acquire SIB31 in order to stay synchronized.

In IoT NTN, since an IoT UE (LTE-M and NB-IoT UE) is not expected to be able to acquire system information in connected mode, the UE tunes away and is likely unreachable while reading SIB31.

If the IoT NTN UE is unable to read the SIB31 within a timer (T318) with a configured duration, the UE performs Radio Link Failure (RLF) similar to other cases where RLF is performed.

In NR NTN, the UE shall ensure that the UE has a recent ephemeris (SIB19 in NR) by reading the SIB in time by UE implementation.

### Overview of NTN Handover

An NTN handover in IoT NTN is similar to a normal handover. The handover is usually triggered by measurement reports sent by the UE, that are triggered by a condition that is configured by the eNB.

The handover command sent to a UE is a RRCReconfiguration element that includes the mobility ControlInfo. The mobilityControlInfo contains information like the target cell physicalCellId, the target cell carrier and bandwidth, along with timers for how long the handover may take as well as RACH-configuration to use to perform the handover.

As a handover command to a UE is supposed to provide everything needed to perform basic operation in the cell, in NTN it was agreed that the SIB31 is required to be provided in a RRCReconfiguration message when performing mobility.

The entirety of the RRCReconfiguration message is configured by the target CNB and provided in the RRC HandoverCommand message (which is include in the X2 message HANDOVER REQUEST). To allow for UE capability-compliant configuration, the target cell includes the UE capabilities in the HandoverPreparationInformation message (included in the HANDOVER REQUEST ACKNOWLEDGE X2 message) sent by the source eNB to the target eNB when requesting a handover to be performed.

### Overview of Conditional Handover

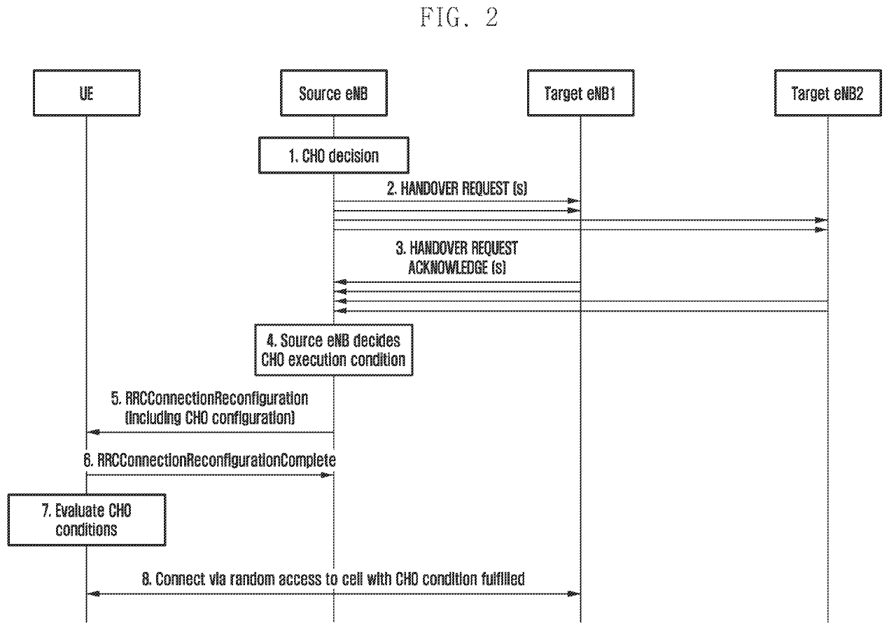

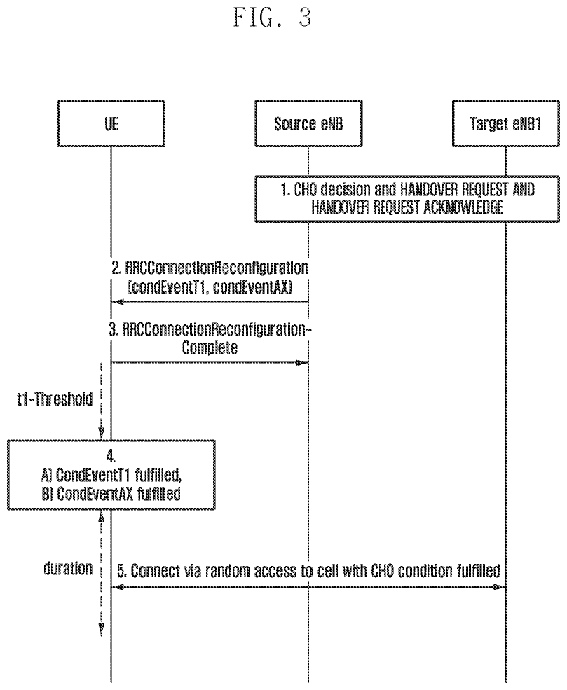

Conditional handover was introduced in Release 16 for both E-UTRAN and NR. Conditional handovers is a way to enable more reliable handovers. A full conditional handover procedure can be seen in FIG. 2.

The steps involved in a conditional handover may include:
1. Source eNB decides to configure UE with conditional handover.
2. Handover requests are sent to target eNBs. One handover request per cell typically needs to be sent to an eNB. This means that the source eNB may have to send multiple HANDOVER REQUEST messages to each eNB. The source eNB includes the RRC message HandoverPreparationInformation in the HANDOVER REQUEST message. This contains UE capabilities, Access Stratum configuration and more.
3. Similarly as above, the target eNBs sends a reply (HANDOVER REQUEST ACKNOWLEDGE) for each cell. This message contains the full RRCConnectionReconfiguration (or RRCReconfiguration) message to use in the target cell.
4. Source eNB decides on the conditional handover configuration using all of the received responses from the eNBs. This includes deciding the CHO execution condition.
5. RRCConnectionReconfiguration includes the CHO configuration.
6. RRCConnectionReconfigurationComplete (or RRCReconfigurationComplete) that confirms the receipt of the CHO configuration (nothing in error or success). For a normal handover this will only be sent to the target cell after handover complete.
7. The UE here evaluates the CHO conditions. This can be performed for a very long time until the CHO condition for a cell is fulfilled. As an example, a UE could in theory be configured with the CHO configuration when connected to a gNB and maintain these configurations for a long time.
8. When the CHO condition is fulfilled for a given cell, the UE synchronizes and connects with this cell via random access and sends the RRCConnectionReconfigurationComplete to the target cell (i.e., target eNB or gNB).

The originally introduced conditional handover events are the following:
Conditional Handover Event A3 (CondEvent A3): Based on event A3 (non-conditional handover event). This is defined as [3GPP TS 38.331, V17.3.0] “Neighbour becomes offset better than SpCell”
Conditional Handover Event A5 (CondEvent A5): Based on event A5 (non-conditional handover event). This is defined as [3GPP TS 38.331, V17.3.0] “SpCell becomes worse than threshold1 and neighbour becomes better than threshold2”

### Overview of NR NTN Conditional Handover Enhancements

For NR NTN a set of new conditional handover conditions were introduced specifically for NTN. These are the following:
Conditional Handover Event T1 (CondEvent T1):
   This is defined as (3GPP TS 38.331, V17.3.0) “CondEvent T1: Time measured at UE becomes more than configured threshold t1-Threshold but is less than t1-Threshold+duration”
   The conditional handover event is considered fulfilled when the time at the UE is larger than t1-Threshold but smaller than t1-Threshold+duration. After t1-Threshold+duration, the UE the condition is no longer considered fulfilled.
   This is useful as the movement of satellite cells are rather predictable as they travel along an orbit. This means that when a handover should be necessary is fairly predictable if the UE position is known. Thus the network can configure in advance when conditional handover should be performed, saving signalling when the coverage may be less good and ensuring that handovers are performed even if there is a momentary disruption when on the UE is at the cell edge. This can be seen in FIG. 3.
   Conditional event T1 cannot be configured alone, but may need to be accompanied by a Radio Frequency (RF)-based conditional event, such as Conditional Event A3-A5. This is to avoid any accidental handover to a cell with low signal strength.
Conditional Handover Event D1 (CondEvent D1):
   This is defined as: “CondEvent D1: Distance between UE and a reference location referenceLocation1 becomes larger than configured threshold distanceThreshFromReference1 and distance between UE and a reference location referenceLocation2 of conditional reconfiguration candidate becomes shorter than configured threshold distanceThreshFromReference2;”
   This is related to the fact that UE position may be more beneficial to use for mobility purposes compared to (only) using RF characteristics, due to how the long-term RF characteristics tend to be flat (e.g., similar RF characteristics) over a satellite cell.
   The event allows for triggering of measurement report when the UE is outside of a specific area, and this area could for instance be the same area as that of a satellite cell.
   Conditional event D1 cannot be configured alone, but may need to be accompanied by a RF-based conditional event, such as Conditional Event A3-A5. This is to ensure that a handover to a cell with low signal strength is not performed.

### Overview of RACH-less

RACH-less is a handover method introduced in E-UTRAN Release 14. RACH-less enables a UE to skip performing random access during a handover. This is to improve the delay of handovers in some certain cases.

RACH-less can be performed in certain cases related to the Timing Advance (TA):
When TA to the target cell is equal to zero.
When TA to the target cell is equal to the TA of the source cell.

RACH-less can be said to have two different methods:
Consecutive Uplink Grants are configured to be used by the UE to send the first message after the handover, which is the RRCReconfigurationComplete and optionally any data. For this case, the UE is configurated with an uplink grant (ul-Grant), the scheduling interval (ul-SchedInterval) as well as how many occasions that are configured (numberOfConfUL-Processes).
The UE is scheduled to synchronize with a cell without sending any messages to the target cell. Instead the UE starts monitoring Physical Downlink Control Channel (PDCCH) for assignments from the target cell. The assignments may be for downlink Physical Downlink Shared Channel (PDSCH) transmissions or UL grants for the UE to send Physical Uplink Shared Channel (PUSCH).

The following fields are configured with RACH-less:
targetTA
numberOfConfUL-Processes
ul-SchedInterval
ul-StartSubframe
ul-Grant

The above information is presented as background information only to assist with an understanding of the present disclosure. No determination has been made, and no assertion is made, as to whether any of the above might be applicable as prior art with regard to the present disclosure.

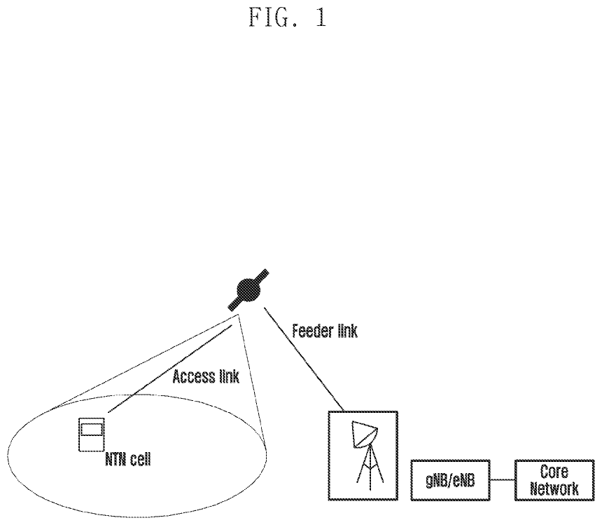

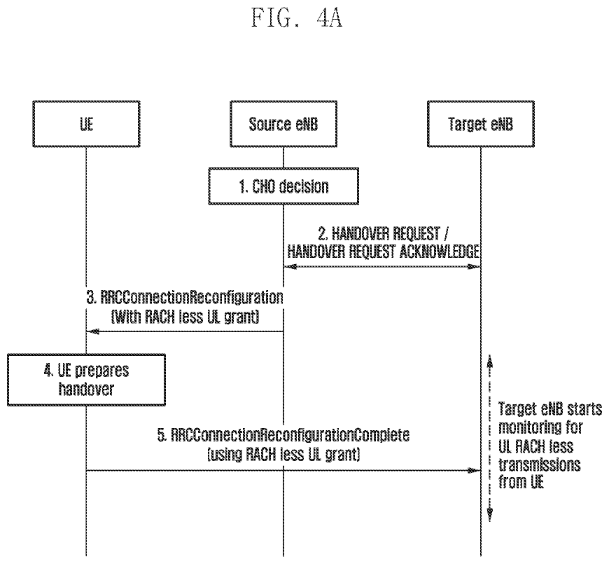

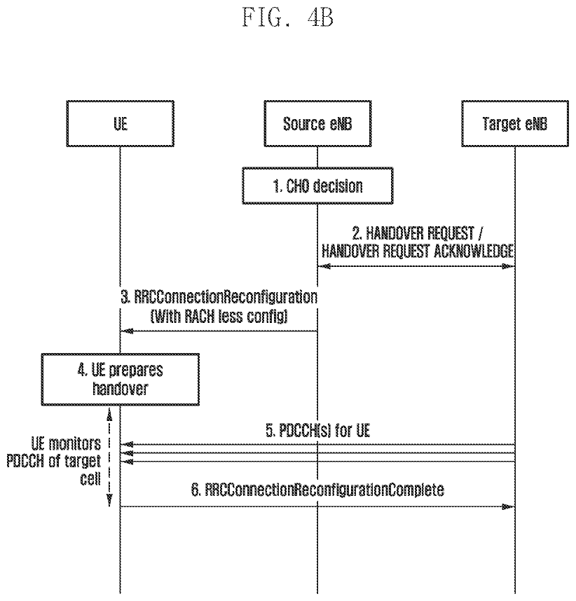

FIGS. 1 through 12 discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description of examples of the present disclosure, with reference to the accompanying drawings, is provided to assist in a comprehensive understanding of the present disclosure, as defined by the claims. The description includes various specific details to assist in that understanding but these are to be regarded as merely exemplary. Accordingly, those of ordinary skill in the art will recognize that various changes and modifications of the examples described herein can be made without departing from the scope of the disclosure.

The same or similar components may be designated by the same or similar reference numerals, although they may be illustrated in different drawings.

Detailed descriptions of techniques, structures, functions, operations or processes known in the art may be omitted for clarity and conciseness, and to avoid obscuring the subject matter of the present disclosure.

The terms and words used herein are not limited to the bibliographical or standard meanings, but, are merely used to enable a clear and consistent understanding of the disclosure.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, the singular form, for example “a”, “an” and “the”, encompasses the plural unless the context otherwise requires. For example, reference to “an object” includes reference to one or more of such objects.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless incompatible therewith.

The skilled person will appreciate that the techniques described herein may be used in any suitable combination.

Certain examples of the present disclosure provide one or more techniques for performing handover in a network. For example, certain examples of the present disclosure provide one or more techniques for performing CHO with RACH-less in a 3GPP 5G NR NTN. However, the skilled person will appreciate that the present disclosure is not limited to these examples, and may be applied in any suitable system or standard, for example one or more existing and/or future generation wireless communication systems or standards, including any existing or future releases of the same standards specification, for example 3GPP 5G.

The functionality of the various network entities and other features disclosed herein may be applied to corresponding or equivalent entities or features in the same or any other suitable communication systems or standards. Corresponding or equivalent entities or features may be regarded as entities or features that perform the same or similar role, function or purpose within the network. For example, the functionality of a base station or the like (e.g., cNB, gNB, NB, RAN node, access point, wireless point, transmission/reception point, central unit, distributed unit, radio unit, remote radio head, etc.) in the examples below may be applied to any other suitable type of entity performing RAN functions, and the functionality of a UE or the like (e.g., electronic device, user device, mobile station, subscriber station, customer premises equipment, terminal, remote terminal, wireless terminal, vehicle terminal, etc.) in the examples below may be applied to any other suitable type of device.

A particular network entity may be implemented as a network element on a dedicated hardware, as a software instance running on a dedicated hardware, and/or as a virtualised function instantiated on an appropriate platform, e.g., on a cloud infrastructure.

The skilled person will appreciate that the present disclosure is not limited to the specific examples disclosed herein. For example:
The techniques disclosed herein are not limited to 3GPP 5G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements or entities may be added to the examples disclosed herein.
One or more non-essential elements or entities may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed and/or the order in which messages are transmitted may be modified, if possible, in alternative examples.

Certain examples of the present disclosure may be provided in the form of an apparatus/device/network entity configured to perform one or more defined network functions and/or a method therefor. Certain examples of the present disclosure may be provided in the form of a system (e.g., network or wireless communication system) comprising one or more such apparatuses/devices/network entities, and/or a method therefor.

In Release 18 IoT NTN, 3GPP is working on introducing conditional handover for IoT NTN as can be seen from the WID [RP-220979, RAN #95-e March 2022], which is incorporated by reference herein:
4.1.2 Mobility enhancements
   The following mobility enhancements objectives are listed.
      Support of neighbour cell measurements and corresponding measurement triggering before RLF, using Rel-17 (TN) NB-IoT, eMTC as a baseline. [RAN2]
      Re-use the solutions introduced in Rel-17 NR NTN for mobility enhancements for eMTC, with minimum necessary changes to adapt them to eMTC [RAN2]
      Define UE RRM core requirements for the above mobility enhancement features [RAN4].

Conditional handover was enhanced in NR NTN by introducing the time-based conditional handover execution, whereby the conditional handover event is partly based on the time having passed a given time-point.

RACH-less and NTN has been discussed several times, mainly due to the fact that the Timing Advance may have some special properties in NTN. First of all, the Timing Advance to a target cell may be exactly equal to the source cell Timing Advance due to two cells emanating from the same satellite. In fact in many scenarios, the most common type of handovers will be intra-satellite handovers. Secondly, the Timing Advance is UE-calculated using satellite ephemeris and UE position. This means that it may be possible to perform RACH-less handovers quite well if the UE has accurate UE position and satellite ephemeris.

RACH-less handovers have recently been discussed in 3GPP, where the reply is positive towards utilizing RACH-less handovers in NR NTN. The following was stated in reply to a Liaison from RAN2 to RAN1 (LS R2-2300020):
For scenario (1), from RAN1 perspective the RACH-less handover is possible, assuming the following notes can be satisfied, when UE UL transmission synchronization can be maintained by applying pre-compensation using the assistance information, e.g., epoch time, ephemeris, common TA, of the target cell.
For scenario (2)-(4), from RAN1 perspective the RACH-less handover may be possible, assuming the following notes can be satisfied, when UE UL transmission synchronization can be maintained by applying pre-compensation using the assistance information, e.g., epoch time, ephemeris, common TA, of the target cell.
Note 1: RAN1 assumes that the RAN4 UL synchronization requirement specified in Table 7.1C.2-1 of TS38.133 applies to the first UL transmission in the target cell.
Note 2: gNB is expected to provide valid assistance information of the target cell to UE.
Note 3: gNB is expected to ensure the UE can perform the UL transmission while respecting common TA and UE processing time.

Where the scenarios 1-4 are:
(1) Intra-satellite handover with the same feeder link. i.e., with same gateway/gNB
(2) Intra-satellite handover with different feeder links, i.e., with gateway/gNB switch
(3) Inter-satellite handover with gateway/gNB switch
(4) Inter-satellite handover with same gateway/gNB

If RACH-less and CHO is configured together, which can be very useful to reduce RACH congestion, then there can be some issues. In CHO, the source eNB decides on the condition for CHO (3GPP TS 36.300, V17.3.0):
7. The source eNB sends a RRCConnectionReconfiguration message to the UE, containing configuration of CHO candidate cell(s) and CHO execution condition(s). The source eNB decides on the condition for the execution of CHO and adds the condition(s) to the RRC message sent to the UE.

The issue is that with CHO and RACH-less, the source eNB will decide on execution condition for CHO, but target eNB decides on whether to use RACH-less. The target eNB has to know when the RACH-less handover is being performed to start blind decoding UL traffic or using PDCCH to schedule the UE performing RACH-less handover.

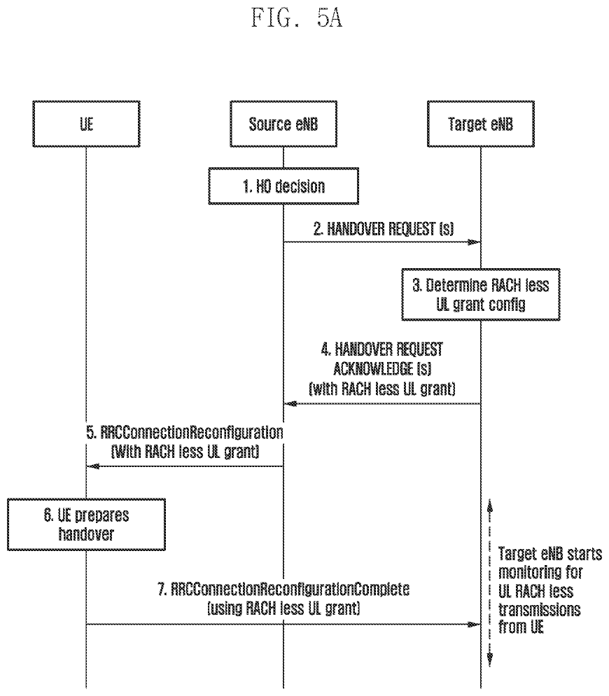

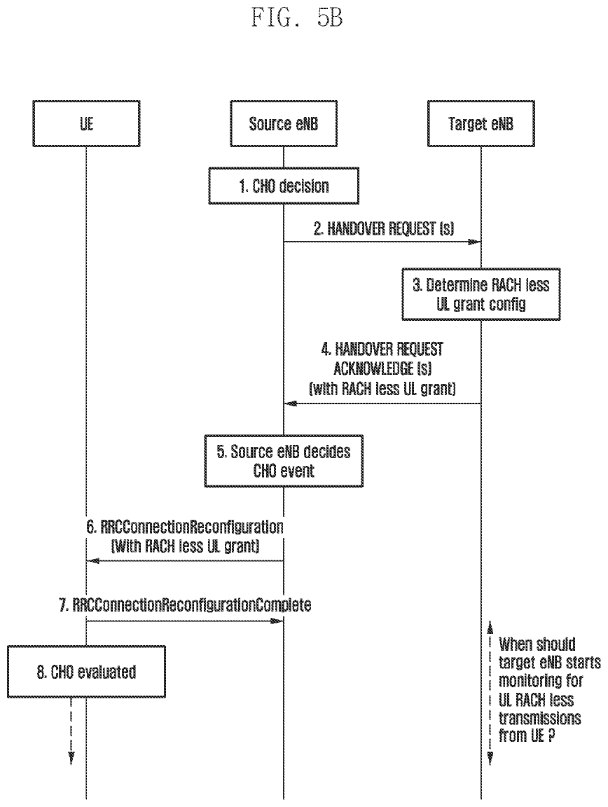

FIGS. 5A and 5B show two types of HO: (a) normal HO with RACH-less, and (b) CHO with RACH-less. In (a) the UE uses RACH-less resources that may always be monitored and the target eNB may directly start monitoring for UL transmissions or schedule the UE to perform RACH-less handover. However, in (b) the target eNB is not aware when the target eNB should start monitoring for UL RACH-less transmissions from the UE. Without the ability to know when to start monitoring for UL RACH less grants, the target eNB may be forced to monitor for a very long time.

The problem is similar for the case when RACH-less is done through the UE monitoring for PDCCH assignments (i.e., UL grants are not configured for RACH-less). In this case the target eNB would have to blindly send PDCCH assignments for a very long time.

### Signalling Ephemeris for CHO

One issue related to signalling the ephemeris for CHO is that in the current way for signalling the ephemeris for a handover in IoT NTN is included via a dedicated SIB31. For CHO, this means that each cell has its own associated ephemeris element. This means that if 8 cells are included in a CHO configuration, then 8 ephemeris elements may need to be signalled. This may make the conditional handover command excessively large.

Certain examples of the present disclosure provide various techniques for enabling RACH-less and CHO.

Many of the examples in the present disclosure involves the use of Conditional Handover event T1, as this is the most likely candidate to be used with RACH-less. However, the skilled person will appreciate that the techniques disclosed herein are not limited to this case. There can for instance be future events that utilize time that can be considered as well as other RF and/or location based conditional handover events.

Certain examples of the present disclosure may also be applicable in other cases where a time-sensitive handover configuration is given along with CHO.

Various examples of the present disclosure involve RACH-less using UL grant. However, the skilled person will appreciate that other ways of configuring the UE to monitor PDCCH, and then the target eNB sends PDCCHs containing UL grant, are also applicable.

Various examples of the present disclosure involve using eNBs (4G E-UTRAN). However, the skilled person will appreciate that the techniques disclosed herein may equally apply to gNBs or NG-RAN (5G NR). The techniques may also apply to a eMTC/LTE-M UE, or 5G NR UE, or E-UTRAN UE. In addition, while the techniques are described in the context of NTN, they may also apply outside of NTN, for example in a terrestrial network (e.g., regular 5G network).

Certain examples of the present disclosure provide a method, for a second base station in a network comprising a User Equipment (UE), a first base station, and the second base station, the method for performing Random Access Channel (RACH)-less handover of the UE from the first base station to the second base station, the method comprising: obtaining a Conditional Handover (CHO) configuration (e.g., execution condition); determining a RACH-less Uplink (UL) grant configuration; transmitting, to the first base station, the RACH-less UL grant (e.g., in a HANDOVER REQUEST ACK message); and monitoring for UL RACH-less transmissions from the UE (e.g., a RRCConnectionReconfigurationComplete message) or scheduling Physical Downlink Control Channel (PDCCH) assignments to the UE, based on the CHO configuration.

In certain examples, obtaining the CHO configuration may comprise one or more of: generating a new CHO configuration; identifying an existing CHO configuration; modifying an existing CHO configuration; and updating an existing CHO configuration.

In certain examples, obtaining the CHO configuration may comprise receiving, from the first base station, a CHO execution condition (e.g., in a HANDOVER REQUEST message).

In certain examples, obtaining the CHO configuration may comprise: receiving, from the first base station, a request to determine a CHO execution condition (e.g., in a HANDOVER REQUEST message); determining the CHO execution condition in response to the request; and transmitting, to the first base station, the CHO execution condition (e.g., in a HANDOVER REQUEST ACK message).

In certain examples, the CHO configuration may comprise an execution condition based on a time-based conditional event (e.g., CHO Event T1), the method may comprise obtaining a time threshold (e.g., t1-Threshold), and monitoring for UL RACH-less transmissions may be performed based on the time threshold.

In certain examples, the method may further comprise: determining, based on the CHO configuration, whether RACH-less handover and/or conditional handover shall be used or not; and transmitting, to the first base station, an indication of a result of the determination.

In certain examples, the method may further comprise determining, based on the received CHO configuration, whether or not to obtain a different CHO configuration.

In certain examples, the network may comprise a Non-Terrestrial Network (NTN), and the second base station may be associated with an NTN cell.

Certain examples of the present disclosure provide a base station configured to perform a method according to any example, aspect, embodiment and/or claim disclosed herein.

Certain examples of the present disclosure provide a network (or wireless communication system) comprising a first base station, a second base station, and a UE according to any example, aspect, embodiment and/or claim disclosed herein.

Certain examples of the present disclosure provide a computer program comprising instructions which, when the program is executed by a computer or processor, cause the computer or processor to carry out a method according to any example, aspect, embodiment and/or claim disclosed herein.

Certain examples of the present disclosure provide a computer or processor-readable data carrier having stored thereon a computer program according to any example, aspect, embodiment and/or claim disclosed herein.

### RACH-less and CHO

CHO configuration sent by the source cell (source eNB, NG-RAN, or gNB)

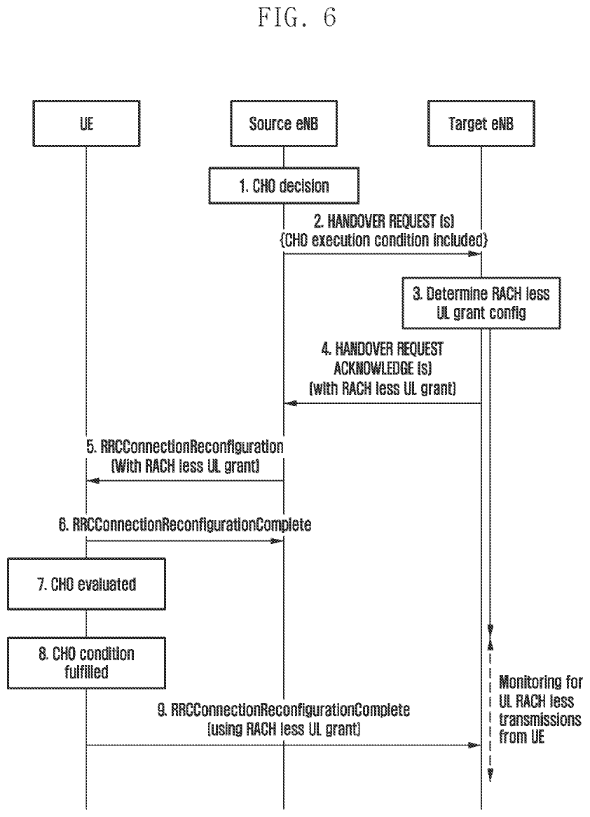

In certain examples, the CHO execution condition is sent over X2 (or Xn) from the source to target eNB (or NG-RAN, gNB) as seen in FIG. 6. For example, as a new Information Element (IE) (CHO Execution Condition IE, or any other suitable naming) included in HANDOVER REQUEST message (and/or any other suitable newly defined or existing Xn/X2 message). One example of including a new IE in HandoverPreparationInformation can be seen in specification example #1 further below.

Upon receiving the new IE, the target eNB (or NG-RAN, gNB) can use this information for a number of reasons, for example:
Use the information to monitor future RACH less UL transmissions, or to schedule future PDCCH assignments to the UE, if RACH-less is configured.
Configure a suitable RACH-less HO configuration(s).
   For example, target eNB (or NG-RAN, gNB) configures RACH-less UL grants taking into consideration the CHO triggering conditions.
Configure (or modify or update) suitable CHO execution condition(s).
   For example, considering the RACH-less HO configuration(s), and/or other information available at the target eNB (or NG-RAN or gNB). For example, information related to the UE (mobility, velocity, etc.).
Confirm (or decide) whether RACH-less HO shall be used or not.
   This decision is reported (or indicated) to the source eNB (or NG-RAN, gNB). For example included in the HANDOVER REQUEST ACKNOWLEDGE message (and/or any other suitable newly defined or existing Xn/X2 message).
Confirm (or decide) whether the conditional handover configuration is suitable or another configuration would be more suitable.
Send recommendations to the source eNB (or NG-RAN, gNB) on modifying (or updating) the configured (or used) CHO execution condition.
   For example, adjusts CHO execution condition considering the RACH-less UL grants, configured by the target eNB (or NG-RAN, gNB).
Reject the conditional handover.
   For example with a suitable cause value included in the HANDOVER REQUEST FAILURE. (new cause: CHO and RACH-less not supported, CHO condition not suitable, or any other suitable naming).

The steps are as follows:
1. Source eNB decides to configure UE with conditional handover.
2. Handover requests are sent to target eNB containing the CHO execution condition included. This can be the full execution conditions (up to 2 execution conditions), or only one execution condition, i.e., the most important one.
3. As explained in the examples above, the Target eNB decides whether to use RACH less configuration or not. The target eNB uses the CHO execution conditions to determine when to monitor for UL RACH-less transmissions or to schedule PDCCH assignments to the UE.

Steps 5-9 may be performed similarly to corresponding steps of FIGS. 2 and/or 3.

The source eNB requests whether RACH less can be used over X2 (or Xn) or not. The target eNB can respond depending on conditions whether RACH less is suitable or not.

In certain examples, CHO and RACH-less can only be used with timed handovers using conditional event T1. Source eNB sends the t1-threshold, the duration or the full configuration condEventT1 if used, or as discussed above, the CondEventT1 configuration. The source eNB does then have to use the CondEventT1. This can be seen in specification example #2 further below. Another wording of this is that when a network (set of eNBs) configure a RACH less and CHO, the condEventT1 is included.

In certain examples, the CHO execution condition is included in the Access Stratum config in the HandoverPreparationInformation as if the UE is currently configured with the condition (this message shall normally reflect the current configuration of the UE). To let the UE know that the current configuration has yet to be configured, but is rather an attempt to convey the suggested configuration, the HandoverPreparationInformation message can contain a flag to indicate that the included CHO execution condition has yet to be configured, but is the suggested one.

### CHO Config Sent by Target Cell

In certain examples, the CHO execution condition is sent over X2 (or Xn) from target to source cell. The execution condition or part of the execution condition is configured by the target eNB. As a special example, the target eNB determines the condEventT1 only. This can for instance be if the target eNB has determined that RACH less should be used with CHO, and then the target eNB will include a condEventT1 that the source eNB shall configure. If the source eNB continues with configuring the CHO, the source eNB has to utilize the target eNBs condEventT1 as one of the conditional events (up to 2 events can be configured to be fulfilled in order for CHO condition to be fulfilled for a single cell). This allows the target eNB to be fully aware of when to start monitoring for UL transmissions or when to start scheduling a UE with PDCCH transmissions.

As a specific example, the CondEventT1 can be configured by target eNB if the RACH less is used. The target eNB first determines that RACH less would be beneficial and that the UE is capable of RACH less. The target eNB then determines the time that the event should be fulfilled.

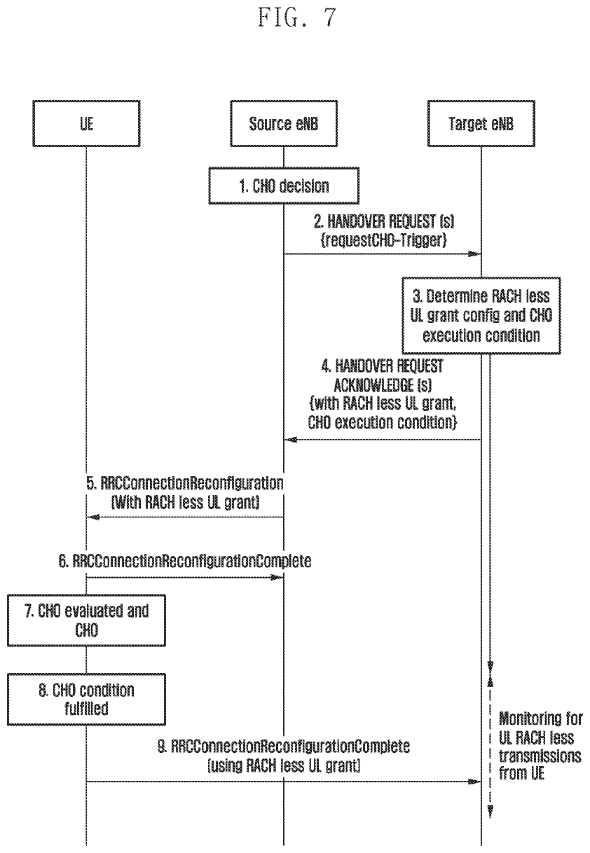

The source eNB may optionally request the CHO configuration to be configured by the target cell. This can be seen in specification example #2 further below and in FIG. 7. The conditional handover event trigger is only sent if the target cell determines that the conditional handover event trigger may be needed. Otherwise, the source cell configures the CHO as needed.

In certain examples, the eNBs (gNBs, NG-RANs) configure the above behavior in X2 (Xn) Setup (using X2/XN SETUP REQUEST and X2/XN SETUP RESPONSE) when performing CHO. This means that an eNB may indicate that the eNB wants the CHO execution condition to be sent to the eNB or that an eNB wants to determine the CHO condition when another eNB wants to perform CHO. This can include the conditions above.

### Further Examples when Combining CHO and RACH-Less

If the duration of condEventT1 expires and the UE is configured with RACH-less, the UE may perform handover using RACH to the target eNB selected. In other words, RACH-less will not be used if the duration of condEventT1 expires. This can also be considered that the RACH-less configuration is valid during the Conditional Handover event T1.

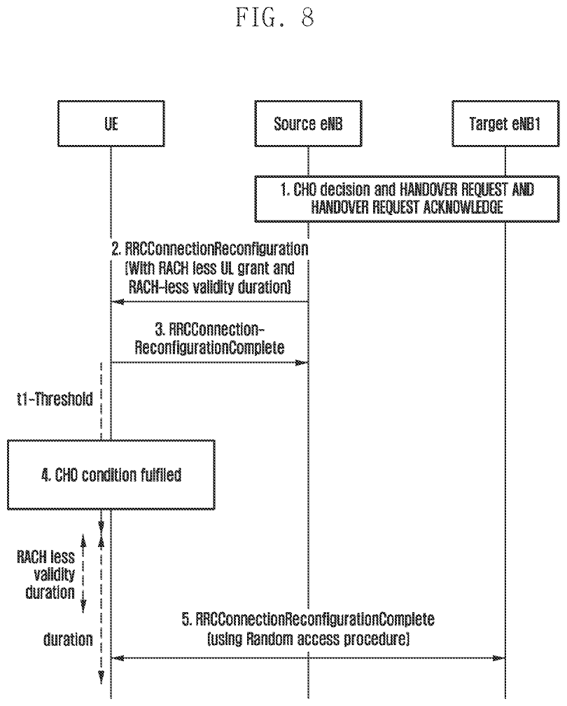

In certain examples, a validity duration for RACH less is included for the UE. Beyond the RACH-less duration, normal handover is used. This can be used to limit how long RACH-less can be used in order for the target eNB to save resources. This technique is illustrated in FIG. 8. The RACH-less validity duration can be defined in the following manners:
A single point in time (defined via a specific time, or a specific System Frame Number (SFN) or subframe) when the RACH-less cannot be used/RACH-less configuration is removed/indicated to Medium Access Control (MAC) to not perform RACH-less handover.
A single point in time when the RACH-less configuration can be used. This can be used by the current RACH-less configuration that has fields such as numberOfConfUL-Processes and ul-SchedInterval which gives the number of UL processes that may be sent.
A time window defined by a start point and a duration (defined via a specific time, or a specific SFN, subframe and time duration or and number of subframes) under which RACH less may be performed. This can be seen in specification example #5 below.

The above can be used to make RACH-less consume a suitable amount of resources. For example, the RACH-less validity duration can be in the middle of the duration for CondEventT1 and only be used in this time window as a way to optimize the resources used. If the conditional handover event is fulfilled before the RACH-less validity duration, the UE performs normal handover using random access.

The above may also be valid for the case where a UE is not configured with RACH-less UL grants but rather is configured to monitor for PDCCH. The UE may in this case be configured to monitor for PDCCH under a certain duration, and if nothing is received, then the UE proceeds with performing random access.

Due to the above RACH-less validity duration may be rather long where the signal quality can change significantly, making RACH-less less suitable. So in certain examples, a threshold is introduced to configure a UE to perform conditional handover with normal random access procedure. This threshold can be based on an Reference Signal Receive Power (RSRP) threshold where if the RSRP with the target cell is below a threshold, RACH-less handover is not performed and normal random access procedure is used.

The validity duration can be configured by the target eNB and/or the source eNB, using the techniques described above under the heading “RACH-less and CHO”.

Additionally, certain fields of RACH-Skip may be extended when used with CHO as seen in specification example #6 further below:
numberofConfUL-Processes—this is the number of UL grants provided.
   Values: INTEGER (1 . . . 16)
   In an alternative example, this field is not included if a RACH-less validity duration is defined. Thus the UE assumes the UE can send as many UL grants as the validity duration allows.
Include different types of ul-Grant
   Currently the uplink grant only uses a specific uplink grant that only contains a limited amount of possibilities for the target eNB to configure the UE.
Repetition configuration
   This allows for repetitions during RACH-less, which can be essential for many IoT use cases.
   This can include repetitions for PDCCH monitoring, or repetitions of the UL transmissions contained in the UL grants.
   It can also be configured whether the UE shall be in Coverage Enhancement (CE) mode A or CE mode B. This controls the maximum number of repetitions configured.
TargetTA
   It may be indicated for an NTN UE that the NTN UE shall apply the Timing Advance as calculated by the UE according to the UE's position and the ephemeris, as is done for a normal handover when random access is performed. This can be a separate flag such as applyTA-NTN. In another case, when these fields are not present, it may indicate that the UE shall the Timing Advance according to the above.

One problem with CHO compared to normal handovers is that CHO request is usually sent out too many cells/eNBs, because there are usually many potential cells that the UE should evaluate to perform handovers to. In the case of using RACH-less with CHO, this means that there is no certainty whether the UE will select one cell and perform handover to it. This means that the RACH-less resources that have been reserved in the target eNB may be wasted. Thus the target eNB may need to have assistance information sent to target eNB to consider whether RACH-less is suitable, such as:
How many cells that the source eNB is sending out the CHO request(s) to.
   If the source eNB sends the handover request(s) indicating the request being sent to 6 cells, for example, the target eNB can estimate the likelihood (or chance or probability) of the CHO being performed being ⅙, which can be used to determine whether RACH-less is suitable. As an example, the target eNB would likely consider the chance being too low for the RACH-less resource to be valuable and would thus not decide to configure RACH-less resources.
   This could for instance be a flag indicating that the specific target cell is the only cell requested to be configured for CHO.
The likeliness that the UE will perform handover to the specific target cell.
Whether the UE is likely to remain in RRC connected mode in order to perform CHO.
   This could be important in some cases where the traffic sent is not very high and there is a likeliness that the UE will not remain in RRC connected mode and not perform any CHO.
   This could be implicitly signaled by including the buffer status or traffic characteristics of the UE.
In the case where location-related conditional handover event (CondEventD1) is configured:
   The location of the UE and additionally the speed and direction of the UE.

In certain examples, when configuring RACH-less with CHO, there can be requirements related to what ephemeris that is signalled. This can for instance be that the validity duration of the ephemeris is smaller compared to when operating normally. RACH-less may not be performed if the ephemeris is not recent enough, but normal handovers using random access may be performed.

In certain examples, the UE indicates to source cell (or source eNB) if the ephemeris in the CHO configuration has expired. This can allow a source cell (or source eNB) to re-send the ephemeris, for instance by reconfiguring the CHO configuration for that specific cell. Similarly, if the ephemeris of a cell associated with a CHO configuration has expired, the UE will attempt to re-acquire the ephemeris, for instance from elements (or information) broadcasted by the source or target cell, or provided by other type of signaling (e.g., dedicated signaling (RRC signalling)) by the source and/or target eNB.

### Signalling Ephemeris in CHO

In certain examples, only the required ephemeris elements are signalled, i.e., only the ephemeris elements of the associated satellites or eNBs are included and the ephemeris is not signaled per cell.

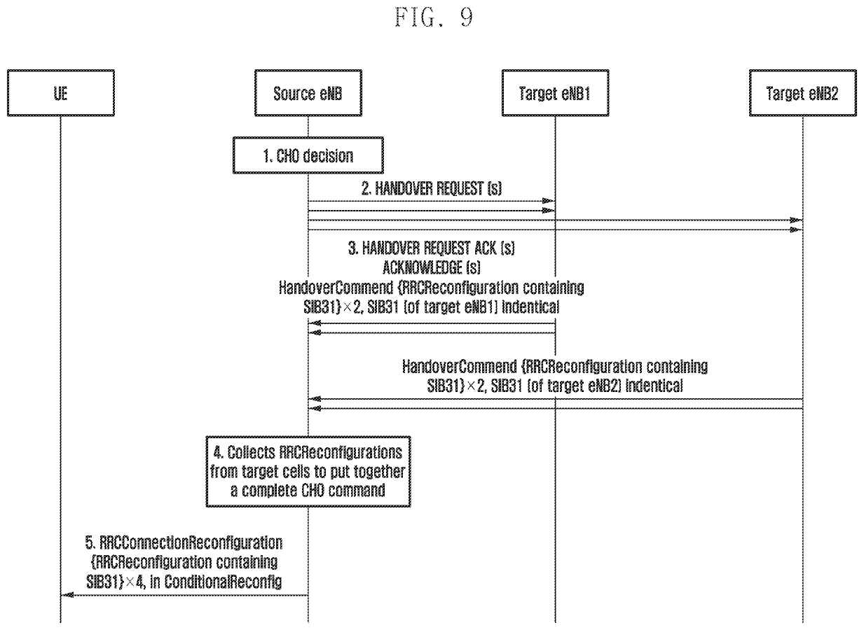

One problem with the implementing the above is that the SIB31 element that is included in a CHO config for each cell, is generated by the relevant target eNB and the RRCReconfiguration is generated per target cell by the target eNB. This can be seen in FIG. 9.

Thus in order to solve this problem, a target eNB would need to only include the ephemeris for one of the target eNBs.

One way to do this is to introduce a mapping through for instance an ephemeris Id that indicates which ephemeris that a UE should apply. This can be done in the following manner:
The network may signal an associated ephemeris Id in a CHO configuration.
For the UE:
   If the SIB31 is present and an ephemeris Id is present, this defines the specific Id. The UE uses the ephemeris if a CHO handover is triggered.
   If the SIB31 is not present and the ephemeris Id is present, the uses the ephemeris Id to find a configured ephemeris.
The target eNB will generate RRCReconfiguration with SIB31 as:
   For the first received HANDOVER REQUEST for a specific UE and a specific cell, generate a SIB31 and an ephemeris Id.
   For the following received HANDOVER REQUEST for a specific UE and another cell, include only the ephemeris Id of the first cell.
The source cNB may include an ephemerisId number in the HandoverPreparationInformation in the HANDOVER REQUEST sent to the target eNB requesting the handover.

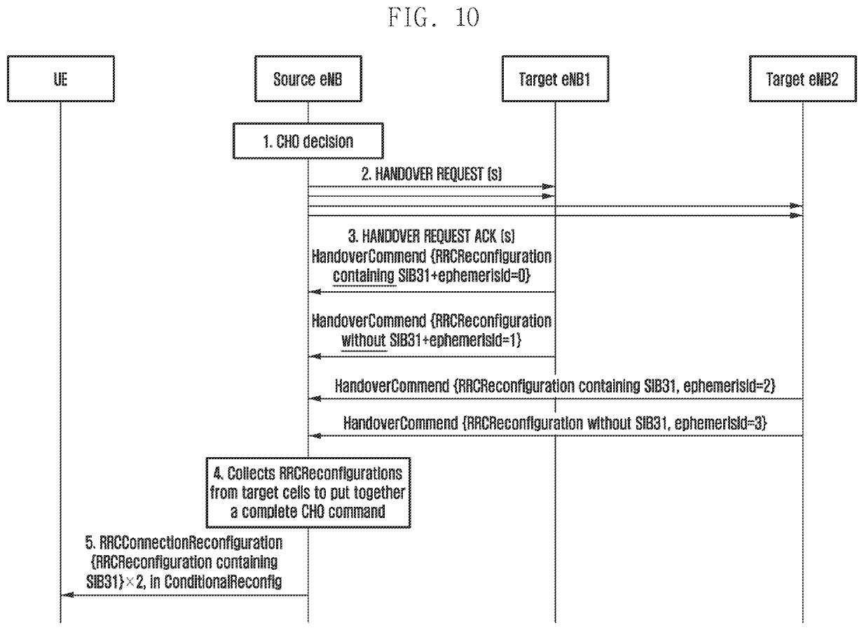

This example can be seen in FIG. 10. The benefit of the above approach is that the already introduced handover mechanisms (i.e., the non-CHO handover mechanism) can be largely kept as is without needing significant changes.

In certain examples, when signalling the ephemeris in a CHO configuration, if the ephemeris of a target cell/eNB is not included, the UE assumes that the cell is associated with the same satellite as that of the source cell/eNB. This could for instance be done through a flag in the configurations. This is important for CHO as the CHO configuration may become very large. Similarly, if there are multiple cells that are associated with a single target eNB/satellite, there can be signalling such as a specific ID that identifies the satellite ephemeris so that only a single ephemeris element may need to be signaled. This can for instance be an ephemerisId.

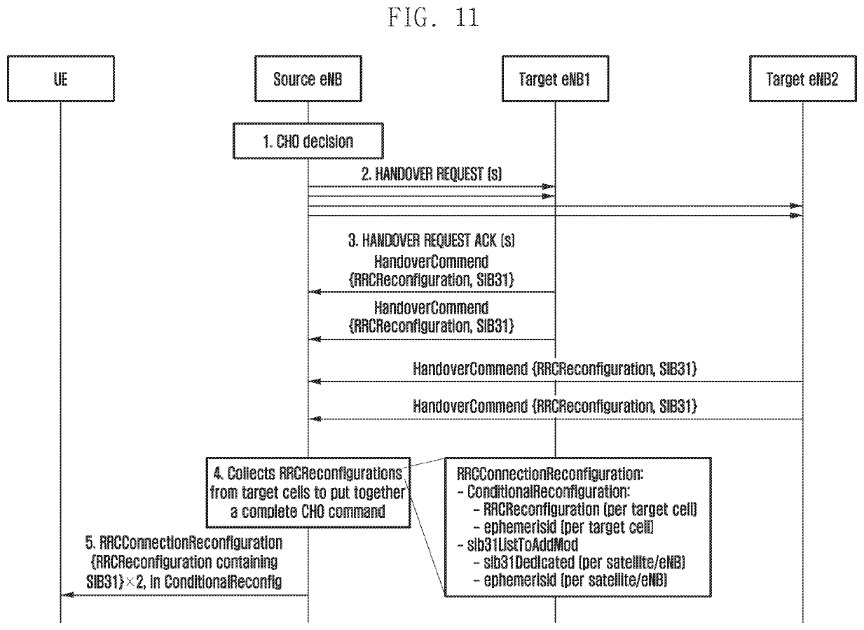

In alternative examples, the target cell does not include the ephemeris or the dedicated SIB31 in the RRCReconfiguration sent to the source cell, but rather includes the SIB31 in a separate information element of the HandoverCommand. Then the source eNB may compare the different received ephemeris or dedicated SIB31 elements, and decide how to collect the information based on whether the SIB31 is the same or very similar. The ephemeris or the dedicated SIB31 may then instead of being configured in a conditional configuration separate from the per-cell RRCReconfiguration within a conditional handover. This example can be seen in FIG. 11. The benefit of this approach is that it is more flexible but requires more signaling changes.

In certain examples, the target eNB is configured to not include any ephemeris or any dedicated SIB31, but rather the source eNB will include a (new SIB) dedicated SIB containing neighbor cell ephemeris elements (it is expected that 3GPP will introduce a new SIB containing only neighbor cell ephemeris). The conditional handover configuration may then include a mapping through for instance an ephemeris ID.

The notion of an ephemerisId may similarly be a SIB-id, specifically referring to the SystemInformationBlockType31, i.e., that not only the ephemeris is the same among different cells, but also that the SIB31 is the same across the cells. This except for the ephemeris includes the common TA, the uplink sync validity duration, the epoch time as well as timing-related aspects such as k-Offset and k-Mac.

Similarly, in certain examples above, the SIB31 is signaled via target cell to source cell. This can also be signaled via an ephemeris element instead of SIB31. Ephemeris is important, but the common TA is also important for accessing a cell. This means that the both the ephemeris and common TA may be included in an information element for the purposes of reduced CHO signalling.

### SPECIFICATION EXAMPLES

### Example 1

RRC 36.331 17.3.0 example
   HandoverPreparationInformation.
      This message is used to transfer the E-UTRA RRC information used by the target eNB or target ng-eNB during handover preparation or UE context retrieval, e.g., in case of resume or re-establishment, including UE capability information.
         Direction: source eNB/source RAN to target eNB or target ng-eNB
      HandoverPreparationInformation message is as follows in Table 5.

### Table 5

-- ASN1START

| HandoverPreparationInformation ::= | | SEQUENCE { |
|---|---|---|
| criticalExtensions | | CHOICE { |
| | c1 | CHOICE{ |
| | handoverPreparationInformation-r8 | HandoverPreparationInformation- |

r8-IEs,

| spare7 NULL, | |
|---|---|
| spare6 NULL, spare5 NULL, spare4 NULL, | |
| spare3 NULL, spare2 NULL, spare1 NULL | |
| }, | |
| criticalExtensionsFuture | SEQUENCE { } |

}
}

| HandoverPreparationInformation-r8-IEs ::= | | SEQUENCE { |
|---|---|---|
| ue-RadioAccessCapabilityInfo | | UE-CapabilityRAT-ContainerList, |
| as-Config | | AS-Config |
| | OPTIONAL, | -- Cond HO |
| rrm-Config | | RRM-Config |
| | OPTIONAL, | |
| as-Context | | AS-Context |
| | OPTIONAL, | -- Cond HO |

| | |
|---|---|
| nonCriticalExtension | HandoverPreparationInformation-v920- |

| | |
|---|---|
| IEs | OPTIONAL |

}
<OMITTED>
HandoverPreparationInformation-v1700-IEs ::= SEQUENCE {

| | |
|---|---|
| as-Config-v1700 | AS-Config-v1700 |

OPTIONAL, -- Cond HO5

| | |
|---|---|
| nonCriticalExtension | HandoverPreparationInformation-v1800-IEs OPTIONAL |

}
HandoverPreparationInformation-v1800-IEs ::= SEQUENCE {

| | |
|---|---|
| condReconfigurationTrigger-r18 | CondReconfigurationTriggerEUTRA-r16 |

OPTIONAL,

| | |
|---|---|
| nonCriticalExtension | SEQUENCE { } |

OPTIONAL

}
-- ASN1STOP

Descriptions for various fields set forth in Table 5 are provided in Table 6 below.

TABLE 6
HandoverPreparationInformation field descriptions

as-Config
The radio resource configuration. Applicable in case of intra-E-UTRA handover, resume or
re-establishment. If the target receives an incomplete MeasConfig and/or
RadioResourceConfigDedicated in the as-Config, the target eNB may decide to apply the
full configuration option based on the ue-ConfigRelease.
as-Context
Local E-UTRAN context required by the target eNB.
condReconfigurationTrigger
Conditional handover configuration the source eNB is planning to use.
makeBeforeBreakReq
To request the target eNB to add the makeBeforeBreak indication in the mobilityControlInfo
in case of intra-frequency handover.
rrm-Config
Local E-UTRAN context used depending on the target node's implementation, which is
mainly used for the RRM purpose. May also be provided at inter-RAT handover from NR.
sourceRB-ConfigIntra5GC
NR radio bearer config used at intra5GC handover, resume or re-establishment, as defined
by RadioBearerConfig IE in TS 38.331 [82].
ue-ConfigRelease
Indicates the RRC protocol release or version applicable for the current UE configuration.
This could be used by target eNB to decide if the full configuration approach should be used.
If this field is not present, the target assumes that the current UE configuration is based on
the release 8 version of RRC protocol. NOTE 1.
ue-RadioAccessCapabilityInfo
For E-UTRA radio access capabilities, it is up to E-UTRA how the backward compatibility
among supportedBandCombinationReduced, supportedBandCombination and
supportedBandCombinationAdd is ensured. If supportedBandCombinationReduced and
supportedBandCombination/supportedBandCombinationAdd are included into
ueCapabilityRAT-Container, it can be assumed that the value of fields, requestedBands,
reducedIntNonContCombRequested and requestedCCsXL are consistend with all supported
band combination fields. NOTE 2
ue-SupportedEARFCN
Includes UE supported EARFCN of the handover target E-UTRA cell if the target E-UTRA
cell belongs to multiple frequency bands.

### Example 2

RRC 36.331 17.3.0 example
   HandoverPreparationInformation.
      This message is used to transfer the E-UTRA RRC information used by the target eNB or target ng-eNB during handover preparation or UE context retrieval, e.g., in case of resume or re-establishment, including UE capability information.
         Direction: source eNB/source RAN to target eNB or target ng-cNB.
      HandoverPreparationInformation message is as follows in Table 7.

TABLE 7
-- ASN1START

| | |
|---|---|
| HandoverPreparationInformation ::= | SEQUENCE { |
| criticalExtensions | CHOICE { |

| | |
|---|---|
| c1 | CHOICE{ |

| | |
|---|---|
| handoverPreparationInformation-r8 | HandoverPreparationInformation- |

r8-IEs,

| spare7 NULL, | |
|---|---|
| spare6 NULL, spare5 NULL, spare4 NULL, | |
| spare3 NULL, spare2 NULL, spare1 NULL | |
| }, | |
| criticalExtensionsFuture | SEQUENCE { } |

}
}

| HandoverPreparationInformation-r8-IEs ::= | | SEQUENCE { |
|---|---|---|
| ue-RadioAccessCapabilityInfo | | UE-CapabilityRAT-ContainerList, |
| as-Config | | AS-Config |
| | OPTIONAL, | -- Cond HO |
| rrm-Config | | RRM-Config |
| | OPTIONAL, | |
| as-Context | | AS-Context |
| | OPTIONAL, | -- Cond HO |

| | |
|---|---|
| nonCriticalExtension | HandoverPreparationInformation-v920- |

| | |
|---|---|
| IEs | OPTIONAL |

}
<OMITTED>
HandoverPreparationInformation-v1700-IEs ::= SEQUENCE {

| | |
|---|---|
| as-Config-v1700 | AS-Config-v1700 |

OPTIONAL, -- Cond HO5

| | | |
|---|---|---|
| nonCriticalExtension | HandoverPreparationInformation-v1800-IEs | OPTIONAL |

}
HandoverPreparationInformation-v1800-IEs ::= SEQUENCE {

| | | |
|---|---|---|
| condEventT1-Config-r18 | CondEventT1-r17 | OPTIONAL, |

| | |
|---|---|
| nonCriticalExtension | SEQUENCE { } |

OPTIONAL

}
-- ASN1STOP

Descriptions for various fields set forth in Table 7 are provided in Table 8 below.

TABLE 8
HandoverPreparationInformation field descriptions

as-Config
The radio resource configuration. Applicable in case of intra-E-UTRA handover, resume or
re-establishment. If the target receives an incomplete MeasConfig and/or
RadioResourceConfigDedicated in the as-Config, the target eNB may decide to apply the
full configuration option based on the ue-ConfigRelease.
as-Context
Local E-UTRAN context required by the target eNB.
condEventT1-Config
The conditional handover configuration condEventT1 the source eNB is planning to use.
makeBeforeBreakReq
To request the target eNB to add the makeBeforeBreak indication in the mobilityControlInfo
in case of intra-frequency handover.
rrm-Config
Local E-UTRAN context used depending on the target node's implementation, which is
mainly used for the RRM purpose. May also be provided at inter-RAT handover from NR.
sourceRB-ConfigIntra5GC
NR radio bearer config used at intra5GC handover, resume or re-establishment, as defined
by RadioBearerConfig IE in TS 38.331 [82].
ue-ConfigRelease
Indicates the RRC protocol release or version applicable for the current UE configuration.
This could be used by target eNB to decide if the full configuration approach should be used.
If this field is not present, the target assumes that the current UE configuration is based on
the release 8 version of RRC protocol. NOTE 1.
ue-RadioAccessCapabilityInfo
For E-UTRA radio access capabilities, it is up to E-UTRA how the backward compatibility
among supportedBandCombinationReduced, supportedBandCombination and
supportedBandCombinationAdd is ensured. If supportedBandCombinationReduced and
supportedBandCombination/supportedBandCombinationAdd are included into
ueCapabilityRAT-Container, it can be assumed that the value of fields, requestedBands,
reducedIntNonContCombRequested and requestedCCsXL are consistend with all supported
band combination fields. NOTE 2
ue-SupportedEARFCN
Includes UE supported EARFCN of the handover target E-UTRA cell if the target E-UTRA
cell belongs to multiple frequency bands.

### Example 3

RRC 38.423 17.3.0 example
   9.1.1.1 HANDOVER REQUEST
   This message is sent by the source NG-RAN node to the target NG-RAN node to request the preparation of resources for a handover (see Table 9 below).
   Direction: source NG-RAN node→target NG-RAN node.

TABLE 9

| | | | | | | |
|---|---|---|---|---|---|---|
| IE/Group | | | IE type and | Semantics | | Assigned |
| Name | Presence | Range | reference | description | Criticality | Criticality |

| | | | | | |
|---|---|---|---|---|---|
| Message | M | 9.2.3.1 | | YES | reject |
| Type | | | | | |
| Source | M | NG-RAN | Allocated at | YES | reject |
| NG-RAN | | node UE | the source | | |
| node UE | | XnAP ID | NG-RAN node | | |
| XnAP ID | | 9.2.3.16 | | | |
| reference | | | | | |
| Cause | M | 9.2.3.2 | | YES | reject |
| Target Cell | M | 9.2.3.25 | Includes | YES | reject |
| Global ID | | | either an | | |
| | | | E-UTRA | | |
| | | | CGI or an | | |
| | | | NR CGI | | |
| . . . | . . . | | | | |
| Conditional | O | | | YES | reject |
| Handover | | | | | |
| Information | | | | | |
| Request | | | | | |
| >CHO | M | ENUMERATED | | — | |
| Trigger | | (CHO- | | | |
| | | initiation, | | | |
| | | CHO- | | | |
| | | replace, . . . ) | | | |
| >Target | C- | NG-RAN | Allocated at | — | |
| NG-RAN | ifCHO | node UE | the target | | |
| node UE | mod | XnAP ID | NG-RAN node | | |
| XnAP ID | | 9.2.3.16 | | | |
| >Estimated | O | INTEGER | | — | |
| Arrival | | (1 . . . 100) | | | |
| Probability | | | | | |
| >CHO | O | XXX | Decided by | — | — |
| Execution | | | the source | | |
| Condition(s) | | | NG-RAN node | | |
| . . . | | | | | |

### Example 4

RRC 36.331 17.3.0 example
   HandoverPreparationInformation.
      This message is used to transfer the E-UTRA RRC information used by the target eNB or target ng-eNB during handover preparation or UE context retrieval, e.g., in case of resume or re-establishment, including UE capability information.
         Direction: source eNB/source RAN to target eNB or target ng-eNB
      HandoverPreparationInformation message is as follows in Table 10.

TABLE 10
-- ASN1START

| HandoverPreparationInformation ::= | | SEQUENCE { |
|---|---|---|
| criticalExtensions | | CHOICE { |
| | c1 | CHOICE{ |
| | handoverPreparationInformation-r8 | HandoverPreparationInformation- |

r8-IEs,

| spare7 NULL, | |
|---|---|
| spare6 NULL, spare5 NULL, spare4 NULL, | |
| spare3 NULL, spare2 NULL, spare1 NULL | |
| }, | |
| criticalExtensionsFuture | SEQUENCE { } |

}
}

| HandoverPreparationInformation-r8-IEs ::= | | SEQUENCE { |
|---|---|---|
| ue-RadioAccessCapabilityInfo | | UE-CapabilityRAT-ContainerList, |
| as-Config | | AS-Config |
| | OPTIONAL, | -- Cond HO |
| rrm-Config | | RRM-Config |
| | OPTIONAL, | |
| as-Context | | AS-Context |
| | OPTIONAL, | -- Cond HO |

| | |
|---|---|
| nonCriticalExtension | HandoverPreparationInformation-v920- |

| | |
|---|---|
| IEs | OPTIONAL |

}
<OMITTED>
HandoverPreparationInformation-v1700-IEs ::= SEQUENCE {

| | |
|---|---|
| as-Config-v1700 | AS-Config-v1700 |

OPTIONAL, --Cond HO5

nonCriticalExtension HandoverPreparationInformation-v1800-IEs OPTIONAL
}
HandoverPreparationInformation-v1800-IEs ::= SEQUENCE {

| | |
|---|---|
| requestCHO-Trigger-r18 | ENUMERATED {true} |

OPTIONAL,

| | |
|---|---|
| nonCriticalExtension | SEQUENCE { } |

OPTIONAL

}
-- ASN1STOP

Descriptions for various fields set forth in Table 10 are provided in Table 11 below.

TABLE 11
HandoverPreparationInformation field descriptions

as-Config
The radio resource configuration. Applicable in case of intra-E-UTRA handover, resume or
re-establishment. If the target receives an incomplete MeasConfig and/or
RadioResourceConfigDedicated in the as-Config, the target eNB may decide to apply the
full configuration option based on the ue-ConfigRelease.
as-Context
Local E-UTRAN context required by the target eNB.
requestCHO-Trigger
Used by source eNB to request the target eNB to configure the conditional handover trigger
configuration.
makeBeforeBreakReq
To request the target eNB to add the makeBeforeBreak indication in the mobilityControlInfo
in case of intra-frequency handover.
rrm-Config
Local E-UTRAN context used depending on the target node's implementation, which is
mainly used for the RRM purpose. May also be provided at inter-RAT handover from NR.
sourceRB-ConfigIntra5GC
NR radio bearer config used at intra5GC handover, resume or re-establishment, as defined
by RadioBearerConfig IE in TS 38.331 [82].
ue-ConfigRelease
Indicates the RRC protocol release or version applicable for the current UE configuration.
This could be used by target eNB to decide if the full configuration approach should be used.
If this field is not present, the target assumes that the current UE configuration is based on
the release 8 version of RRC protocol. NOTE 1.
ue-RadioAccessCapabilityInfo
For E-UTRA radio access capabilities, it is up to E-UTRA how the backward compatibility
among supportedBandCombinationReduced, supportedBandCombination and
supportedBandCombinationAdd is ensured. If supportedBandCombinationReduced and
supportedBandCombination/supportedBandCombinationAdd are included into
ueCapabilityRAT-Container, it can be assumed that the value of fields, requestedBands,
reducedIntNonContCombRequested and requestedCCsXL are consistend with all supported
band combination fields. NOTE 2
ue-SupportedEARFCN
Includes UE supported EARFCN of the handover target E-UTRA cell if the target E-UTRA
cell belongs to multiple frequency bands.

<OMITTED>
   HandoverCommand.
      This message is used to transfer the handover command generated by the target cNB.
         Direction: target eNB to source eNB/source RAN.
      HandoverCommand message is as follows in Table 12.

TABLE 12
-- ASN1START

| | |
|---|---|
| HandoverCommand ::= | SEQUENCE { |
| criticalExtensions | CHOICE { |
| c1 | CHOICE{ |

```
      handoverCommand-r8
  HandoverCommand-r8-IEs,
      spare7 NULL,
      spare6 NULL, spare5 NULL, spare4 NULL,
      spare3 NULL, spare2 NULL, spare1 NULL
```

| | |
|---|---|
| }, | SEQUENCE { } |

```
    criticalExtensionsFuture
  }
}
```

| | |
|---|---|
| HandoverCommand-r8-IEs ::= | SEQUENCE { |
| handoverCommandMessage | OCTET STRING (CONTAINING |

DL-DCCH-Message),

| | |
|---|---|
| nonCriticalExtension | HandoverCommand-r18-IEs |

OPTIONAL
}

| | |
|---|---|
| HandoverCommand-r18-IEs ::= | SEQUENCE { |
| condReconfigurationTrigger-r18 | CondReconfigurationTriggerEUTRA-r16 |

OPTIONAL,

| | |
|---|---|
| nonCriticalExtension | SEQUENCE { } |

OPTIONAL
}
-- ASN1STOP

Descriptions for various fields set forth in Table 12 are provided in Table 13 below.

TABLE 13
HandoverCommand field descriptions

handover CommandMessage
Contains the entire DL-DCCH-Message including the RRCConnectionReconfiguration
message used to perform handover within E-UTRAN or handover to E-UTRAN, generated
(entirely) by the target eNB.
condReconfigurationTrigger
Contains the conditional handover trigger configuration that is configured by the target eNB.
If included, the source eNB configures these conditional handover triggers when configuring
conditional handover to the target eNB. The source eNB does not configure conditional
handover if this field is not included and requestCHO-Trigger is included in
HandoverPreparationInformation sent to target eNB to prepare for conditional handover.

### Example 5

RRC 36.331 17.3.0 example
   Mobility ControlInfo.
      The IE MobilityControlInfo includes parameters relevant for network controlled mobility to/within E-UTRA.
   MobilityControlInfo information element is as follows in Table 14.

TABLE 14
-- ASN1START

| | |
|---|---|
| MobilityControlInfo ::= | SEQUENCE { |
| targetPhysCellId | PhysCellId, |
| carrierFreq | CarrierFreqEUTRA |

| | |
|---|---|
| OPTIONAL, | -- Cond HO-toEUTRA2 |

| | |
|---|---|
| carrierBandwidth | CarrierBandwidthEUTRA |

| | |
|---|---|
| OPTIONAL, | -- Cond HO-toEUTRA |

| | |
|---|---|
| additionalSpectrumEmission | AdditionalSpectrumEmission |

| | |
|---|---|
| OPTIONAL, | -- Cond HO-toEUTRA |

| | |
|---|---|
| t304 | ENUMERATED { |
| | ms50, |

ms100, ms150, ms200, ms500, ms1000,

ms2000,

ms10000-v1310},

| | |
|---|---|
| newUE-Identity | C-RNTI, |
| radioResourceConfigCommon | RadioResourceConfigCommon, |
| rach-ConfigDedicated | RACH-ConfigDedicated |

| | |
|---|---|
| OPTIONAL, | -- Need OP |

...,

| | | |
|---|---|---|
| [[ | carrierFreq-v9e0 | CarrierFreqEUTRA-v9e0 |

| | |
|---|---|
| OPTIONAL | -- Need ON |

]],

| | | |
|---|---|---|
| [[ | drb-ContinueROHC-r11 | ENUMERATED {true} |

| | |
|---|---|
| OPTIONAL | -- Cond HO |

]],

| | | |
|---|---|---|
| [[ | mobilityControlInfoV2X-r14 | MobilityControlInfoV2X-r14 OPTIONAL, -- |

Need ON

| | handoverWithoutWT-Change-r14 | ENUMERATED {keepLWA-Config, |
|---|---|---|
| sendEndMarker} | OPTIONAL, | -- Cond HO |
| | makeBeforeBreak-r14 | ENUMERATED {true} |
| OPTIONAL, | -- Need OR | |
| | rach-Skip-r14 | RACH-Skip-r14 |
| OPTIONAL, | -- Need OR | |
| | sameSFN-Indication-r14 | ENUMERATED {true} |

| | |
|---|---|
| OPTIONAL | -- Cond HO-SFNsynced |

```
  ]],
  [[
```

| | mib-RepetitionStatus-r14 | BOOLEAN |
|---|---|---|
| OPTIONAL, | -- Need OR | |
| | schedulingInfoSIB1-BR-r14 | INTEGER (0..31) |

| | |
|---|---|
| OPTIONAL | -- Cond HO-SFNsynced |

]],

| | | |
|---|---|---|
| [[ | daps-Config-r16 | DAPS-Config-r16 |
| | OPTIONAL | -- Cond NotFullConfigHO |

```
  ]],
  [[
```

| | | |
|---|---|---|
| | rach-SkipValidity-r18 | SEQUENCE { |
| | rach-SkipStart-r18 | INTEGER |
| (0..549755813887) | OPTIONAL, | -- Need OR |
| | rach-SkipDuration-r18 | ENUMERATED {100ms, |

| | |
|---|---|
| 200ms, 400ms, 1000ms, 2000ms} | OPTIONAL |

}

]]
}

| | |
|---|---|
| MobilityControlInfo-v10l0 ::= | SEQUENCE { |
| additionalSpectrumEmission-v10l0 | AdditionalSpectrumEmission-v10l0 OPTIONAL |

-- Need ON
}
<OMITTED>

| RACH-Skip-r14 ::= | | SEQUENCE { |
|---|---|---|
| targetTA-r14 | | CHOICE { |
| | ta0-r14 | NULL, |
| | mcg-PTAG-r14 | NULL, |
| | scg-PTAG-r14 | NULL, |
| | mcg-STAG-r14 | STAG-Id-r11, |
| | scg-STAG-r14 | STAG-Id-r11 |

},

| ul-ConfigInfo-r14 | | SEQUENCE { |
|---|---|---|
| | numberOfConfUL-Processes-r14 | INTEGER (1..8), |
| | ul-SchedInterval-r14 | ENUMERATED {sf2, sf5, sf10}, |
| | ul-StartSubframe-r14 | INTEGER (0..9), |
| | ul-Grant-r14 | BIT STRING (SIZE (16)) |

}

OPTIONAL -- Need OR

}
-- ASN1STOP

Descriptions for various fields set forth in Table 14 are provided in Table 15 below.

TABLE 15
MobilityControlInfo field descriptions

<OMITTED>
rach-ConfigDedicated
The dedicated random access parameters. If absent the UE applies contention based
random access as specified in TS 36.321 [6].
rach-Skip
This field indicates whether random access procedure for the target PCell is skipped.
rach-SkipSCG
This field indicates whether random access procedure for the target PSCell is skipped.
rach-Skip-Validity
This field indicates the validity during which rach-Skip can be applied. The field counts
the number of UTC seconds in 10 ms units since 00:00:00 on Gregorian calendar date 1
Jan., 1900 (midnight between Sunday, Dec. 31, 1899 and Monday, Jan. 1,
1900). If the time has been reached, the rach-Skip configuration is removed and indicated
to MAC.
<OMITTED>

### Example 6

RRC 36.331 17.3.0 example
   MobilityControlInfo
      The IE MobilityControlInfo includes parameters relevant for network controlled mobility to/within E-UTRA.
   MobilityControlInfo information element is as follows in Table 16.

### Table 16

-- ASN1START

| | |
|---|---|
| MobilityControlInfo ::= | SEQUENCE { |
| targetPhysCellId | PhysCellId, |
| carrierFreq | CarrierFreqEUTRA |

| | |
|---|---|
| OPTIONAL, | -- Cond HO-toEUTRA2 |

| | |
|---|---|
| carrierBandwidth | CarrierBandwidthEUTRA |

| | |
|---|---|
| OPTIONAL, | -- Cond HO-toEUTRA |

| | |
|---|---|
| additionalSpectrumEmission | AdditionalSpectrumEmission |

| | |
|---|---|
| OPTIONAL, | -- Cond HO-toEUTRA |

| | |
|---|---|
| t304 | ENUMERATED { |
| | ms50, |

ms100, ms150, ms200, ms500, ms1000,

ms2000,

ms10000-v1310},

| | |
|---|---|
| newUE-Identity | C-RNTI, |
| radioResourceConfigCommon | RadioResourceConfigCommon, |
| rach-ConfigDedicated | RACH-ConfigDedicated |

| | |
|---|---|
| OPTIONAL, | -- Need OP |

...,

| | | |
|---|---|---|
| [[ | carrierFreq-v9e0 | CarrierFreqEUTRA-v9e0 |

| | |
|---|---|
| OPTIONAL | -- Need ON |

]],

| | | |
|---|---|---|
| [[ | drb-ContinueROHC-r11 | ENUMERATED {true} |

| | |
|---|---|
| OPTIONAL | -- Cond HO |

]],

| | | |
|---|---|---|
| [[ | mobilityControlInfoV2X-r14 | MobilityControlInfoV2X-r14 OPTIONAL, -- |

Need ON

| | handoverWithoutWT-Change-r14 | ENUMERATED {keepLWA-Config, |
|---|---|---|
| sendEndMarker} | OPTIONAL, | -- Cond HO |
| | makeBeforeBreak-r14 | ENUMERATED {true} |
| OPTIONAL, | -- Need OR | |
| | rach-Skip-r14 | RACH-Skip-r14 |
| OPTIONAL, | -- Need OR | |
| | sameSFN-Indication-r14 | ENUMERATED {true} |

| | |
|---|---|
| OPTIONAL | -- Cond HO-SFNsynced |

```
  ]],
  [[
```

| | mib-RepetitionStatus-r14 | BOOLEAN |
|---|---|---|
| OPTIONAL, | -- Need OR | |
| | schedulingInfoSIB1-BR-r14 | INTEGER (0..31) |

| | |
|---|---|
| OPTIONAL | -- Cond HO-SFNsynced |

]],

| | | |
|---|---|---|
| [[ | daps-Config-r16 | DAPS-Config-r16 |
| | OPTIONAL | -- Cond NotFullConfigHO |

]],

| | |
|---|---|
| [[ rach-Skip-v18 | RACH-Skip-v18 |

| | |
|---|---|
| OPTIONAL, | -- Need OR |

]]
}

| | |
|---|---|
| MobilityControlInfo-v10l0 ::= | SEQUENCE { |
| additionalSpectrumEmission-v10l0 | AdditionalSpectrumEmission-v10l0 OPTIONAL |

-- Need ON
}
<OMITTED>

| RACH-Skip-r14 ::= | | SEQUENCE { |
|---|---|---|
| targetTA-r14 | | CHOICE { |
| | ta0-r14 | NULL, |
| | mcg-PTAG-r14 | NULL, |
| | scg-PTAG-r14 | NULL, |
| | mcg-STAG-r14 | STAG-Id-r11, |
| | scg-STAG-r14 | STAG-Id-r11 |

},

| ul-ConfigInfo-r14 | | SEQUENCE { |
|---|---|---|
| | numberOfConfUL-Processes-r14 | INTEGER (1..8), |
| | ul-SchedInterval-r14 | ENUMERATED { sf2, sf5, sf10}, |
| | ul-StartSubframe-r14 | INTEGER (0..9), |
| | ul-Grant-r14 | BIT STRING (SIZE (16)) |

}

OPTIONAL -- Need OR

}

| RACH-Skip-v18 ::= | | SEQUENCE { |
|---|---|---|
| targetTA-v18 | | CHOICE { |
| | ta0-r18 | NULL, |
| | mcg-PTAG-v18 | NULL, |
| | scg-PTAG-v18 | NULL, |
| | mcg-STAG-v18 | STAG-Id-r11, |
| | scg-STAG-v18 | STAG-Id-r11 |

},

| ul-ConfigInfo-v18 | | SEQUENCE { |
|---|---|---|
| | numberOfConfUL-Processes-v18 | INTEGER (1..16), |
| | ul-SchedInterval-v18 | ENUMERATED{sf2, sf5, sf10, sf20}, |
| | ul-StartSubframe-v18 | INTEGER (0..9), |
| | ul-GrantWithFormat-v18 | SEQUENCE { |
| | formatXy-v18 | BIT STRING |

(SIZE (16))

| | |
|---|---|
| formatXy-v18 | BIT STRING |

(SIZE (18))

| | |
|---|---|
| formatXy-v18 | BIT STRING |

(SIZE (20))

| | |
|---|---|
| formatXy-v18 | BIT STRING |

(SIZE (22))

}

}

| | |
|---|---|
| | OPTIONAL, -- Need OR |
| rach-SkipValidity-r18 | INTEGER (0..549755813887) OPTIONAL |

-- Need OR
}
-- ASN1STOP

Descriptions for various fields set forth in Table 16 are provided in Table 17 below.

TABLE 17
MobilityControlInfo field descriptions

<OMITTED>
rach-ConfigDedicated
The dedicated random access parameters. If absent the UE applies contention based
random access as specified in TS 36.321 [6].
rach-Skip
This field indicates whether random access procedure for the target PCell is skipped.
rach-SkipSCG
This field indicates whether random access procedure for the target PSCell is skipped.
rach-Skip Validity
This field indicates the validity during which rach-Skip can be applied. The field counts
the number of UTC seconds in 10 ms units since 00:00:00 on Gregorian calendar date 1
Jan., 1900 (midnight between Sunday, Dec. 31, 1899 and Monday, Jan. 1,
1900). If the time has been reached, the rach-Skip configuration is removed and indicated
to MAC.
<OMITTED>
ul-Grant With Format
Indicates the resources of the target PCell/PSCell to be used for the uplink transmission of
PUSCH [23], clause 8.8. The formatXy uses Uplink grant format Xy, the formatXy uses
uplink grant format Xy and so on.

### Example 7

RRCConnectionReconfiguration
The RRCConnectionReconfiguration message is the command to modify an RRC connection. It may convey information for measurement configuration, mobility control, conditional reconfigurations (conditional handover, conditional PSCell addition or inter-SN conditional PSCell change), radio resource configuration (including RBs, MAC main configuration and physical channel configuration) including any associated dedicated NAS information and security configuration.
   Signalling radio bearer: SRB1
   RLC-SAP: AM
   Logical channel: DCCH
   Direction: E-UTRAN to UE
RRCConnectionReconfiguration message is as follows in Table 18.

TABLE 18
-- ASN1START

| RRCConnectionReconfiguration ::= | | SEQUENCE { |
|---|---|---|
| | rrc-TransactionIdentifier | RRC-TransactionIdentifier, |
| | criticalExtensions | CHOICE { |
| | c1 | CHOICE{ |
| | | rrConnectionReconfiguration-r8 |
| | RRCConnectionReconfiguration-r8-IEs, | |
| | | spare7 NULL, |
| | | spare6 NULL, spare5 NULL, spare4 NULL, |
| | | spare3 NULL, spare2 NULL, spare1 NULL |
| | }, | |
| | criticalExtensionFuture | SEQUENCE { } |

}

}
RRCConnectionReconfiguration-r8-IEs ::= SEQUENCE {

| | |
|---|---|
| measConfig | MeasConfig |
| | OPTIONAL, -- Need ON |
| mobilityControlInfo | MobilityControlInfo |
| OPTIONAL, | -- Cond HO |
| dedicatedInfoNASList | SEQUENCE (SIZE(1..maxDRB)) |

OF

| DedicatedInfoNAS | OPTIONAL, -- Cond nonHO |
|---|---|
| radioResourceConfigDedicated | RadioResourceConfigDedicated |
| OPTIONAL, -- Cond HO-toEUTRA | |
| securityConfigHO | SecurityConfigHO |
| OPTIONAL, | -- Cond HO-toEPC |
| nonCriticalExtension | RRCConnectionReconfiguration-v890- |

| | |
|---|---|
| IEs | OPTIONAL |

}
<OMITTED>
RRCConnectionReconfiguration-v1700-IEs ::= SEQUENCE {

| | |
|---|---|
| systemInformationBlockType31Dedicated-r17 | OCTET STRING (CONTAINING |

SystemInformationBlockType31-r17)

| OPTIONAL, | -- Cond NTN |
|---|---|
| scg-State-r17 | ENUMERATED{deactivated } |
| | OPTIONAL, -- Need OP |
| nonCriticalExtension | SEQUENCE { } |

OPTIONAL

}
RRCConnectionReconfiguration-v18xy-IEs ::= SEQUENCE {

| ephemerisId-r18 | INTEGER (1..8) |
|---|---|
| OPTIONAL, -- Cond CHONTN | |
| nonCriticalExtension | SEQUENCE { } |

OPTIONAL

}
<OMITTED>
-- ASN1STOP

Descriptions for various fields set forth in Table 18 are provided in Table 19 below.

TABLE 19
RRCConnectionReconfiguration field descriptions

conditionalReconfiguration
This field is used to configure the UE with a conditional reconfiguration. The
reconfiguration is applied when the execution condition(s) is fulfilled. The field is absent if
daps-HO is configured for any DRB or if MobilityControlInfo is included in the
RRCConnectionReconfiguration message. The conditionalReconfiguration is not
configured in the RRCConnectionReconfiguration message included in a
conditionalReconfiguration.
ephemerisId
This field is used to signal the ID of the SystemInformationBlockType31 that the UE shall
use when performing handover in an NTN. If the
systemInformationBlockType31Dedicated is not included, the UE applies the associated
systemInformationBlockType31Dedicated of the rrcConnectionReconfiguration in
condReconfig element indicated by this ID. If the
systemInformationBlockType31Dedicated is included, the UE applies this for the target
cell configuration.
This field is used to transfer SystemInformationBlockType1 or
SystemInformationBlockType1-BR to the UE.
<OMITTED>
systemInformationBlockType1Dedicated
This field is used to transfer SystemInformationBlockType1 or
SystemInformationBlockType1-BR to the UE.
systemInformationBlockType2Dedicated
This field is used to transfer BR version of SystemInformationBlockType2 to BL UEs or
UEs in CE or SystemInformationBlockType2 to non-BL UEs.
systemInformationBlockType31Dedicated
This field is used to transfer SystemInformationBlockType31 to BL UEs or UEs in CE in a
NTN cell.
<OMITTED>

NOTE 1: Fields sk-Counter and nr-RadioBearerConfig½ are placed outside nr-Config, as these may be configured while the UE is not configured with (NG) EN-DC.

NOTE 2: It is not specified whether the timing reference for the SMTC configuration is the source EUTRA PCell or the target EUTRA PCell in case the NR PSCell addition or SN change takes place simultaneously with handover. As a consequence, explicit SMTC configuration is only supported when the source EUTRA PCell and the target EUTRA PCell of the handover are SFN/subframe-synchronized.

NOTE 3: For UEs in RRC_IDLE, RRC_INACTIVE or out-of coverage, and for the case that sl-SSB-PriorityEUTRA is absent, it is up to UE implementation to decide the priority of LTE PSSS/SSSS/PSBCH transmission and reception.

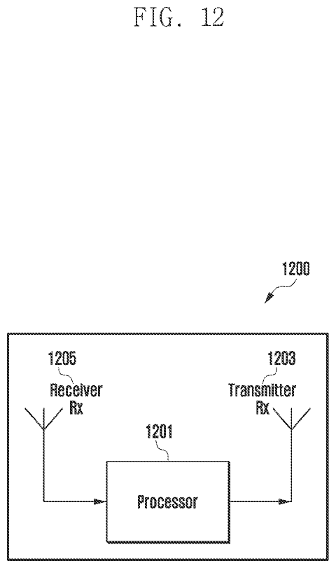

FIG. 12 is a block diagram of an exemplary network entity that may be used in examples of the present disclosure. For example, a UE and/or eNB/gNB in the examples of FIGS. 1-11 may comprise an entity of FIG. 12. The skilled person will appreciate that a network entity may be implemented, for example, as a network element on a dedicated hardware, as a software instance running on a dedicated hardware, and/or as a virtualised function instantiated on an appropriate platform, e.g., on a cloud infrastructure.

The entity 1200 comprises a processor (or controller) 1201, a transmitter 1203 and a receiver 1205. The receiver 1205 is configured for receiving one or more messages from one or more other network entities, for example as described above. The transmitter 1203 is configured for transmitting one or more messages to one or more other network entities, for example as described above. The processor 1201 is configured for performing one or more operations, for example according to the operations as described above.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

While the disclosure has been shown and described with reference to certain examples, it will be understood by those skilled in the art that various changes in form and detail may be made therein without departing from the scope of the disclosure, as defined by the appended claims.

### Abbreviations/Definitions

In the present disclosure, the following in Table 20 acronyms/definitions are used.

TABLE 20

| | |
|---|---|
| 3GPP | 3rd Generation Partnership Project |
| 4G | 4th Generation |
| 5G | 5th Generation |
| ACK | Acknowledgement |
| CE | Coverage Enhancement |
| CHO | Conditional Handover |
| eMTC | enhanced Machine Type Communication |
| eNB | Base Station |
| E-UTRAN | Evolved Universal Terrestrial Radio Access Network |
| GEO | Geosynchronous Equatorial Orbit |
| gNB | 5G Base Station |
| HAPS | High Altitude Platform Station |
| HO | Handover |
| ID | Identity |
| IE | Information Element |
| IoT | Internet of Things |
| LEO | Lower Earth Orbit |
| LTE | Long Term Evolution |
| LTE-M | LTE Machine Type Communication |
| MAC | Medium Access Control |
| NB | Narrowband |
| NG | Next Generation |
| NR | New Radio |
| NTN | Non-Terrestrial Network |
| PDCCH | Physical Downlink Control Channel |
| PDSCH | Physical Downlink Shared Channel |
| PUSCH | Physical Uplink Shared Channel |
| RACH | Randon Access Channel |
| RAN | Radio Access Network |
| Rel | Release |
| RF | Radio Frequency |
| RLF | Radio Link Failure |
| RRC | Radio Resource Control |
| RRM | Radio Resource Management |
| RSRP | Reference Signal Receive Power |
| SFN | System Frame Number |
| SIB | System Information Block |
| TA | Timing Advance |
| TS | Technical Specification |
| Txxx | Timer xxx |
| UE | User Equipment |
| UL | Uplink |
| WID | Work Item Description |
| X2/Xn | Interface between RAN nodes |

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a first base station, the method comprising:
obtaining, from a second base station, a conditional handover (CHO) configuration associated with a time-based trigger condition;
determining an uplink (UL) grant for a time-based CHO; and
transmitting, to a terminal, the UL grant for the time-based CHO,
wherein the time-based CHO is performed based on a random access channel (RACH)-less.

2. The method of claim 1,
wherein the CHO configuration associated with the time-based trigger condition includes at least one information on a time-based conditional event, or information on a time threshold.

3. The method of claim 1, wherein at least one of the first base station or the second base station is associated with a non-terrestrial network (NTN).

4. The method of claim 1, further comprising:
monitoring for a UL RACH-less transmission from the UE based on the CHO configuration associated with the time-based trigger condition.

5. A method performed by a terminal, the method comprising:
receiving, from a first base station, an uplink (UL) grant for a time-based conditional handover (CHO), in case that a CHO configuration associated with a time-based trigger condition is obtained by the first base station from a second base station;
receiving, from the second base station, a control message including information for configuring an UL transmission; and
performing the time-based CHO based on the UL grant and the information for configuring the UL transmission,
wherein the time-based CHO is performed based on a random access channel (RACH)-less.

6. The method of claim 5,
wherein the CHO configuration associated with the time-based trigger condition includes at least one information on a time-based conditional event, or information on a time threshold.

7. The method of claim 5, wherein at least one of the first base station or the second base station is associated with a non-terrestrial network (NTN).

8. The method of claim 5, wherein the information for configuring the UL transmission further includes at least one of first information on a number of HARQ process configured, second information on a number of repetition for the UL transmission, or third information associated with a RACH-less configuration.

9. A first base station, comprising:
a transceiver; and
at least one processor configured to:
obtain, from a second base station, a conditional handover (CHO) configuration associated with a time-based trigger condition,
determine an uplink (UL) grant for a time-based CHO,
transmit, to a terminal via the transceiver, the UL grant for the time-based CHO,
wherein the time-based CHO is performed based on a random access channel (RACH)-less.

10. The first base station of claim 9,
wherein the CHO configuration associated with the time-based trigger condition includes at least one information on a time-based conditional event, or information on a time threshold.

11. The first base station of claim 9,
wherein at least one of the first base station or the second base station is associated with a non-terrestrial network (NTN).

12. The first base station of claim 9, wherein the at least one processor is further configured to:
monitor for a UL RACH-less transmission from the UE based on the CHO configuration associated with the time-based trigger condition.

13. A terminal, comprising:
a transceiver; and
at least one processor configured to:
receive, from a first base station via the transceiver, an uplink (UL) grant for a time-based conditional handover (CHO), in case that a CHO configuration associated with a time-based trigger condition is obtained by the first base station from a second base station,
receive, from the second base station via the transceiver, a control message including information for configuring an UL transmission, and
perform the time-based CHO based on the UL grant and the information for configuring the UL transmission,
wherein the time-based CHO is performed based on a random access channel (RACH)-less.

14. The terminal of claim 13,
wherein the CHO configuration associated with the time-based trigger condition includes at least one information on a time-based conditional event, or information on a time threshold.

15. The terminal of claim 13, wherein at least one of the first base station or the second base station is associated with a non-terrestrial network (NTN).

16. The terminal of claim 13, wherein the information for configuring the UL transmission further includes at least one of first information on a number of HARQ process configured, second information on a number of repetition for the UL transmission, or third information associated with a RACH-less configuration.
